(19) United States
(12) Patent Application Publication
(10) Pub. No.: US 2024/0244708 A1
(43) Pub. Date: Jul. 18, 2024

(54) METHOD AND APPARATUS FOR SUPPORTING NETWORK ENERGY SAVINGS IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Sangkyu BAEK, Suwon-si (KR)

(21) Appl. No.: 18/414,023

(22) Filed: Jan. 16, 2024

Related U.S. Application Data
(60) Provisional application No. 63/467,431, filed on May 18, 2023.

(30) Foreign Application Priority Data
Jan. 18, 2023 (KR) 10-2023-0007585

(51) Int. Cl. H04W 76/28

(52) U.S. Cl. CPC H04W 76/28

(57) ABSTRACT

The disclosure relates to a 5G or 6G communication system for supporting a higher data transmission rate. A method performed by a user equipment (UE) in a wireless communication system is provided. The method includes receiving, from a base station, configuration information on a network discontinuous transmission (DTX) associated with a transmit/receive point (TRP), receiving, from the base station, a first message for activating the network DTX, and stopping a physical downlink control channel (PDCCH) monitoring for the TRP based on the configuration information.

### CROSS-REFERENCE TO RELATED APPLICATION(S)

This application is based on and claims priority under 35 U.S.C. § 119(e) of a U.S. Provisional application Ser. No. 63/467,431, filed on May 18, 2023, in the U.S. Patent and Trademark Office, and under 35 U.S.C. § 119(a) of a Korean patent application number 10-2023-0007585, filed on Jan. 18, 2023, in the Korean Intellectual Property Office, the disclosure of each of which is incorporated by reference herein in its entirety.

### BACKGROUND

### 1. Field

The disclosure relates to a wireless communication system. More particularly, the disclosure relates to an apparatus, a method, and a system for supporting network energy savings in wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide wireless communication systems for supporting network energy savings, leading to discussions about network (NW)/Cell Discontinuous Transmission (DTX). The disclosure are to address problems and/or disadvantages that may arise with the introduction of NW/Cell DTX.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, configuration information on a network discontinuous transmission (DTX) associated with a transmit/receive point (TRP), receiving, from the base station, a first message for activating the network DTX, and stopping a physical downlink control channel (PDCCH) monitoring for the TRP based on the configuration information.

In accordance with another aspect of the disclosure, a method performed by a base station in a wireless communication system is provided. The method includes transmitting, to a UE, configuration information on a DTX associated with a TRP, transmitting, to the UE, a first message for activating the network DTX, and stopping a PDCCH transmission for the TRP according to the configuration information.

In accordance with another aspect of the disclosure, a UE in a wireless communication system is provided. The UE includes a transceiver and a controller. The controller is configured to receive, from a base station via the transceiver, configuration information on a DTX associated with a TRP, receive, from the base station via the transceiver, a first message for activating the network DTX, and stop a PDCCH monitoring for the TRP based on the configuration information.

In accordance with another aspect of the disclosure, a base station in a wireless communication system is provided. The base station includes a transceiver and a controller. The controller is configured to transmit, to a UE via the transceiver, configuration information on a DTX associated with a TRP, transmit, to the UE via the transceiver, a first message for activating the network DTX, and stop a PDCCH transmission for the TRP according to the configuration information.

According to various embodiments of the disclosure, network energy can be efficiently managed in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a Discontinuous Reception (DRX) operation according to an embodiment of the disclosure;

FIG. 2A illustrates an operation of a user equipment (UE) and a base station according to an embodiment of the disclosure;

FIG. 2B illustrates an operation of a user equipment (UE) and a base station according to an embodiment of the disclosure;

FIG. 3A illustrates an operation of a UE and a base station according to an embodiment of the disclosure;

FIG. 3B illustrates an operation of a UE and a base station according to an embodiment of the disclosure;

FIG. 4A illustrates an operation of a UE and a base station according to an embodiment of the disclosure;

FIG. 4B illustrates an operation of a UE and a base station according to an embodiment of the disclosure;

FIG. 5A illustrates an operation of a UE and a base station according to an embodiment of the disclosure;

FIG. 5B illustrates an operation of a UE and a base station according to an embodiment of the disclosure;

FIG. 6A illustrates an operation of a UE and a base station according to an embodiment of the disclosure;

FIG. 6B illustrates an operation of a UE and a base station according to an embodiment of the disclosure;

FIG. 7A illustrates an operation of a UE and a base station according to an embodiment of the disclosure;

FIG. 7B illustrates an operation of a UE and a base station according to an embodiment of the disclosure;

FIG. 8 illustrates an operation of a UE according to an embodiment of the disclosure;

FIG. 9 illustrates an operation of a base station according to an embodiment of the disclosure;

FIG. 10 illustrates an electronic device according to an embodiment of the disclosure; and

FIG. 11 illustrates a base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLLC requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-Radio Access Technology (RAT) Dual Connectivity (MR-DC) operation whereby a UE in RRC_CONNECTED is configured to utilize radio resources provided by two distinct schedulers, located in two different nodes connected via a non-ideal backhaul and providing either Evolved Universal Terrestrial Radio Access Network (E-UTRA) (i.e. if the node is an ng-eNB) or NR access (i.e. if the node is a gNB). In NR for a UE in RRC_CONNECTED not configured with Carrier Aggregation (CA)/DC there is only one serving cell comprising of the primary cell (PCell). For a UE in RRC_CONNECTED configured with CA/DC the term ‘serving cells’ is used to denote the set of cells comprising of the Special Cell(s) (SpCell(s)) and all secondary cells (SCells). In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

System information acquisition in fifth generation wireless communication system: In the fifth generation wireless communication system, node B (gNB) or base station in cell broadcast Synchronization Signal and Physical Broadcast Channel (PBCH) block (SSB) consists of primary and secondary synchronization signals (PSS, SSS) and system information. System information includes common parameters needed to communicate in cell. In the fifth generation wireless communication system (also referred as next generation radio or NR), System Information (SI) is divided into the Master Information Block (MIB) and a number of System Information Blocks (SIBs) where:
the MIB is always transmitted on the BCH with a periodicity of 80 ms and repetitions made within 80 ms and it includes parameters that are needed to acquire SIB1 from the cell.
the SIB1 is transmitted on the Downlink Shared Channel (DL-SCH) with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (Physical Random Access Channel (PRACH) preamble(s) and PRACH resource(s)) for requesting gNB to broadcast one or more SI message(s).
SIBs other than SIB1 are carried in System Information (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.
UE acquires SIB 1 from the camped or serving cell. UE check the BroadcastStatus bit in SIB 1 for SI message which UE needs to acquire. SI request configuration for Supplementary Uplink (SUL) is signaled by gNB using the Information Element (IE) si-RequestConfigSUL in SIB1. If the IE si-RequestConfigSUL is not present in SIB1, UE considers that SI request configuration for SUL is not signaled by gNB. SI request configuration for Normal Uplink (NUL) is signaled by gNB using the IE si-RequestConfig in SIB1. If the IE si-RequestConfig is not present in SIB1, UE considers that SI request configuration for NUL is not signaled by gNB. If SI message which UE needs to acquire is not being broadcasted (i.e. BroadcastStatus bit is set to zero), UE initiates transmission of SI request. The procedure for SI request transmission is as follows:
If SI request configuration is signaled by gNB for SUL, and criteria to select SUL is met (i.e. Reference Signal Received Power (RSRP) derived from SSB measurements of camped or serving cell<rsrp-ThresholdSSB-SUL, where rsrp-ThresholdSSB-SUL is signaled by gNB (e.g. in broadcast signaling such as SIB1)): UE initiate transmission of SI request based on Msg1 based SI request on SUL. In other words, UE initiates Random Access procedure using the PRACH preamble(s) and PRACH resource(s) in SI request configuration of SUL. UE transmits Msg1 (i.e. Random access preamble) and waits for acknowledgement for SI request. Random access resources (PRACH preamble(s) and PRACH occasions(s)) indicated in SI request configuration of SUL is used for Msg1. Msg1 is transmitted on SUL. If acknowledgement for SI request is received, UE monitors the SI window of the requested SI message in one or more SI period(s) of that SI message.
Else if SI request configuration is signaled by gNB for NUL and criteria to select NUL is met (i.e. NUL is selected if SUL is supported in camped or serving cell and RSRP derived from SSB measurements of camped or serving cell>=rsrp-ThresholdSSB-SUL; OR NUL is selected if SUL is not supported in serving cell): UE initiate transmission of SI request based on Msg1 based SI request on NUL (350). In other words, UE initiates Random Access procedure using the PRACH preamble(s) and PRACH resource(s) in SI request configuration of NUL. UE transmits Msg1 (i.e. Random access preamble) and waits for acknowledgement for SI request. Random access resources (PRACH preamble(s) and PRACH occasions(s)) indicated in SI request configuration of NUL is used for Msg1. Msg1 is transmitted on NUL. If acknowledgement for SI request is received, UE monitors the SI window of the requested SI message in one or more SI period(s) of that SI message.
Else UE initiate transmission of SI request based on Msg3 based SI request. In other words, UE initiate transmission of RRCSystemInfoRequest message (345). UE transmits Msg1 (i.e. Random access preamble) and waits for random access response. Common random access resources (PRACH preamble(s) and PRACH occasions(s)) are used for Msg1. In the UL grant received in random access response, UE transmits RRCSystemInfoRequest message and waits for acknowledgement for SI request (i.e. RRCSystemInfoRequest message). If acknowledgement for SI request (i.e. RRCSystemInfoRequest message) is received, UE monitors the SI window of the requested SI message in one or more SI period(s) of that SI message. Note that if SUL is configured, UL carrier for Msg1 transmission will be selected by UE in similar manner as selected by UE for Msg 1 based SI request. SUL is the selected UL carrier, if RSRP derived from SSB measurements of camped or serving cell<rsrp-ThresholdSSB-SUL where rsrp-ThresholdSSB-SUL is signaled by gNB (e.g. in broadcast signaling such as SIB1). NUL is the selected UL carrier, if RSRP derived from SSB measurements of camped or serving cell>=rsrp-ThresholdSSB-SUL where rsrp-ThresholdSSB-SUL is signaled by gNB (e.g. in broadcast signaling such as SIB1).

PDCCH in fifth generation wireless communication system: In the fifth generation wireless communication system, Physical Downlink Control Channel (PDCCH) is used to schedule DL transmissions on Physical Downlink Shared Channel (PDSCH) and UL transmissions on Physical Uplink Shared Channel (PUSCH), where the Downlink Control Information (DCI) on PDCCH includes: Downlink assignments containing at least modulation and coding format, resource allocation, and hybrid-automatic repeat request (ARQ) (HARQ) information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the Physical Resource Block(s) (PRB(s)) and Orthogonal Frequency Division Multiplexing (OFDM) symbol(s) where the UE may assume no transmission is intended for the UE; Transmission of Transmit Power Control (TPC) commands for Physical Uplink Control Channel (PUCCH) and PUSCH; Transmission of one or more TPC commands for Sounding Reference Signal (SRS) transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own Demodulation Reference Signals (DMRS). Quadrature Phase Shift Keying (QPSK) modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

$$( y * ( number of slots in a radio frame ) + x - Monitoring - offset PDCCH slot ) mod ( Monitoring - periodicity - PDCCH - slot ) = 0 ;$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported Subcarrier Spacing (SCS) is pre-defined in NR. Each coreset configuration is associated with a list of Transmission configuration indicator (TCI) states. One DL RS ID (SSB or Channel State Information Reference Signal (CSI RS)) is configured per TCI state. The list of TCI states corresponding to a coreset configuration is signaled by gNB via Radio Resource Control (RRC) signaling. One of the TCI state in TCI state list is activated and indicated to UE by gNB via Medium Access Control (MAC) Control Element (CE). TCI state indicates the DL TX beam (DL TX beam is QCLed with SSB/CSI RS of TCI state) used by GNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

Bandwidth adaptation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request (SR) transmission, secondary cell group (SCG) addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where UE has transmitted Msg1, i.e. RA preamble; 0<s_id<14; t_id is the index of the first slot of the PRACH occasion (0<t_id<80); f_id is the index of the PRACH occasion within the slot in the frequency domain (0<f_id<8), and ul_carrier_id is the UL carrier used for Msg1 transmission (0 for normal UL (NUL) carrier and 1 for supplementary UL (SUL) carrier. Several RARs for various Random access preambles detected by gNB can be multiplexed in the same RAR media access control (MAC) protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step i.e. select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e. cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a physical downlink control channel (PDCCH) addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e. select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for secondary cell (Scell), etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e. during random access resource selection for Msg1 transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e. dedicated preambles/ROs) are provided by gNB, UE select non dedicated preamble. Otherwise UE select dedicated preamble. So during the RA procedure, one random access attempt can be CFRA while other random access attempt can be CBRA.

2 step contention based random access (2 step CBRA): In the first step, UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as MsgB. Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0<s_id<14; t_id is the index of the first slot of the PRACH occasion (0<t_id<80); f_id is the index of the PRACH occasion within the slot in the frequency domain (0<f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e. upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure i.e. UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include UE ID (e.g. random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g. in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case gNB assigns to UE dedicated Random access preamble (s) and PUSCH resource(s) for MsgA transmission. RO(s) to be used for preamble transmission may also be indicated. In the first step, UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. The response is also referred as MsgB.

Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0<s_id<14; t_id is the index of the first slot of the PRACH occasion (0<t_id<80); f_id is the index of the PRACH occasion within the slot in the frequency domain (0<f_id<8), and ul_carrier_id is the UL carrier used for Msg1 transmission (0 for normal UL (NUL) carrier and 1 for supplementary UL (SUL) carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e. during random access resource selection for MsgA transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e. dedicated preambles/Ros/PUSCH resources) are provided by gNB, UE select non dedicated preamble. Otherwise UE select dedicated preamble. So during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signaled by gNB, UE select the signaled carrier for performing Random Access procedure. If the carrier to use for the Random Access procedure is not explicitly signaled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure as specified in section 5.15 of TS 38.321. UE then determines whether to perform 2 step or 4 step RACH for this random access procedure.
If this random access procedure is initiated by PDCCH order and if the ra-PreambleIndex explicitly provided by PDCCH is not 0b000000, UE selects 4 step RACH.
Else if 2 step contention free random access resources are signaled by gNB for this random access procedure, UE selects 2 step RACH.
Else if 4 step contention free random access resources are signaled by gNB for this random access procedure, UE selects 4 step RACH.
Else if the UL BWP selected for this random access procedure is configured with only 2 step RACH resources, UE selects 2 step RACH.
Else if the UL BWP selected for this random access procedure is configured with only 4 step RACH resources, UE selects 4 step RACH.
Else if the UL BWP selected for this random access procedure is configured with both 2 step and 4 step RACH resources,
if RSRP of the downlink pathloss reference is below a configured threshold, UE selects 4 step RACH. Otherwise UE selects 2 step RACH.

Paging in fifth generation wireless communication system: In the 5^{th} generation (also referred as NR or New Radio) wireless communication system UE can be in one of the following RRC state: RRC IDLE, RRC INACTIVE and RRC CONNECTED. The RRC states can further be characterized as follows:
In RRC_IDLE state, a UE specific DRX may be configured by upper layers (i.e. Non-Access Stratum (NAS)). The UE monitors Short Messages transmitted with Paging (P)-RNTI over DCI; Monitors a Paging channel for CN paging using 5G-S-TMSI; Performs neighboring cell measurements and cell (re-)selection; Acquires system information and can send SI request (if configured).
In RRC_INACTIVE state, a UE specific DRX may be configured by upper layers or by RRC layer; In this state, UE stores the UE Inactive Access Stratum (AS) context. A Radio Access Network (RAN)-based notification area is configured by RRC layer. The UE monitors Short Messages transmitted with P-RNTI over DCI; Monitors a Paging channel for Core Network (CN) paging using 5G-S-TMSI and RAN paging using full Inactive (I)-RNTI; Performs neighboring cell measurements and cell (re-)selection; Performs RAN-based notification area updates periodically and when moving outside the configured RAN-based notification area; Acquires system information and can send SI request (if configured).
In the RRC_CONNECTED, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighboring cell measurements and measurement reporting; Acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5G Core (5GC), more specifically to the Access and Mobility Management Function (AMF) by means of the NG-C interface and to the User Plane Function (UPF) by means of the NG-U interface. In the 5^{th} generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more Pos to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in cell. UE first determines the paging frame (PF) and then determines the PO with respect to the determined PF. One PF is a radio frame (10 ms).

The PF for a UE is the radio frame with system frame number ‘SFN’ which satisfies the equation (SFN+PF_offset) mod T=(T div N)*(UE_ID mod N).

Index (i_s), indicating the index of the PO is determined by i_s=floor (UE_ID/N) mod Ns.

T is DRX cycle of the UE.
In RRC_INACTIVE state, T is determined by the shortest of the UE specific DRX value configured by RRC, UE specific DRX value configured by NAS, and a default DRX value broadcast in system information.
In RRC_IDLE state, T is determined by the shortest of UE specific DRX value configured by NAS, and a default DRX value broadcast in system information. If UE specific DRX is not configured by upper layers (i.e. NAS), the default value is applied.

N: number of total paging frames in T.

Ns: number of paging occasions for a PF.

PF_offset: offset used for PF determination.

UE_ID: 5G-S-TMSI mod 1024.

Parameters Ns, nAndPagingFrameOffset, and the length of default DRX Cycle are signaled in SIB1. The values of N and PF_offset are derived from the parameter nAndPagingFrameOffset as defined in TS 38.331. If the UE has no 5G-S-TMSI, for instance when the UE has not yet registered onto the network, the UE shall use as default identity UE_ID=0 in the PF and i_s formulas above.

The PDCCH monitoring occasions for paging are determined based on paging search space configuration (paging-SearchSpace) signaled by gNB.

When SearchSpaceId=0 is configured for pagingSearchSpace, the PDCCH monitoring occasions for paging are same as for RMSI as defined in clause 13 in TS 38.213. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1^{st} PDCCH monitoring occasion for paging in the PF. The gNB may signal parameter firstPDCCH-MonitoringOccasionOfPO for each PO corresponding to a PF. When firstPDCCH-MonitoringOccasionOfPO is signaled, the (i_s+1)^{th} PO is a set of ‘S’ consecutive PDCCH monitoring occasions for paging starting from the PDCCH monitoring occasion number indicated by firstPDCCH-MonitoringOccasionOfPO (i.e. the (i_s+1)^{th} value of the firstPDCCH-MonitoringOccasionOfPO parameter). Otherwise, the (i_s+)^{th} PO is a set of ‘S’ consecutive PDCCH monitoring occasions for paging starting from the (i_s*S)^{th} PDCCH monitoring occasion for paging. ‘S’ is the number of actual transmitted SSBs determined according to parameter ssb-PositionsInBurst signaled in SystemInformationBlock1 received from gNB. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

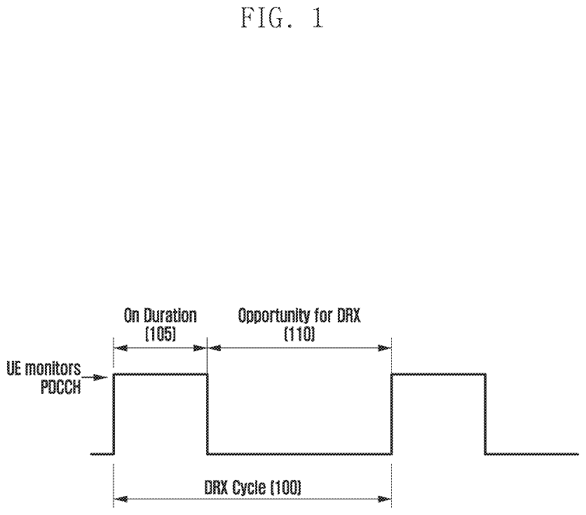

FIG. 1 illustrates a DRX operation according to an embodiment of the disclosure.

Referring to FIG. 1, the DRX operation is repeated in DRX cycles 100, where a DRX cycle 100 is defined as a periodic repetition of the On Duration 105 and opportunity for DRX 110. A DRX cycle 100 in one cycle includes an On Duration 105 and an opportunity for DRX 110.

In 5G wireless communication system, the PDCCH monitoring activity of the UE in RRC connected mode is governed by DRX. When DRX is configured, the UE does not have to continuously monitor PDCCH (addressed to C-RNTI, Cancellation Indication (CI)-RNTI, Configured Scheduling (CS)-RNTI, Interruption (INT)-RNTI, Slot Format Indication (SFI)-RNTI, Semi-persistent (SP)-CSI-RNTI, TPC-PUCCH-RNTI, TPC-PUSCH-RNTI, TPC-SRS-RNTI, AI-RNTI, Sidelink (SL)-RNTI, SLCS-RNTI and SL Semi-Persistent Scheduling V-RNTI). DRX (e.g., connected mode UE specific DRX) is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e. not for retransmissions);
retransmission-timer: duration until a retransmission can be expected;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional).

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer or msgB-ResponseWindow is running; or
a Scheduling Request is sent on PUCCH and is pending. If this Serving Cell is part of a non-terrestrial network, the Active Time is started after the Scheduling Request transmission that is performed when the SR_COUNTER is 0 for all the SR configurations with pending SR(s) plus the UE-gNB Round-Trip Times (RTT); or
a PDCCH indicating a new transmission addressed to the C-RNTI of the MAC entity has not been received after successful reception of a Random Access Response for the Random Access Preamble not selected by the MAC entity among the contention-based Random Access Preamble.

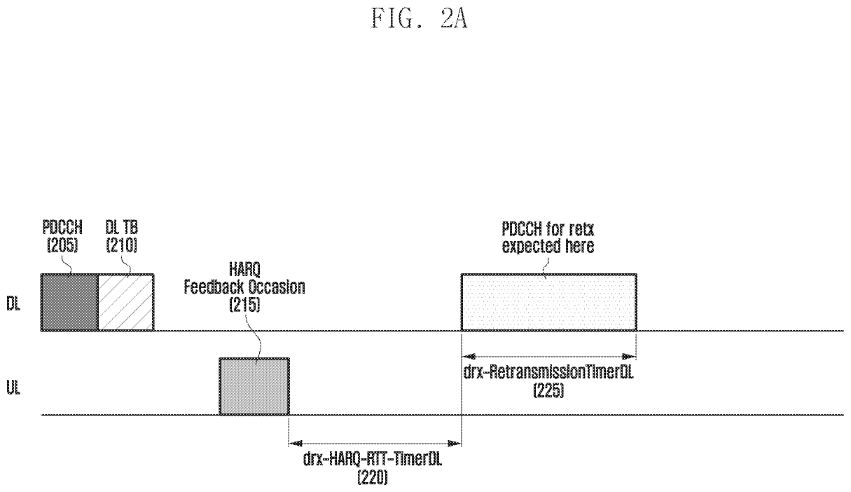

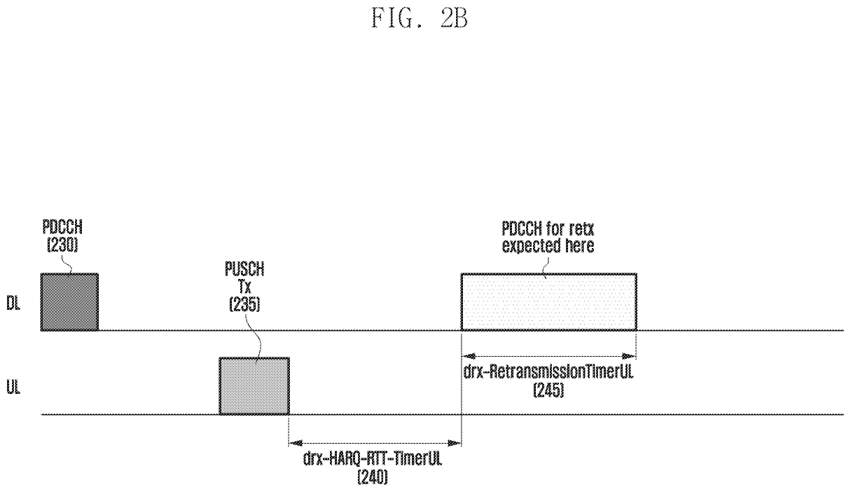

FIG. 2A illustrates an operation of a UE and a base station according to an embodiment of the disclosure.

Referring to FIG. 2A, when Connected Mode UE specific DRX is configured, a UE may:
if the PDCCH (205) indicates a DL transmission block (TB) (210) or if a MAC PDU is received in a configured downlink assignment for unicast:
   start a drx-HARQ-RTT-TimerDL (220) for the corresponding HARQ process in the first symbol after the end of the corresponding transmission carrying the DL HARQ feedback in the HARQ feedback occasion (215);
   stop a drx-RetransmissionTimerDL (225), if running, for the corresponding HARQ process.
if the drx-HARQ-RTT-TimerDL (220) expires:
   if the data of the corresponding HARQ process was not successfully decoded, start the drx-RetransmissionTimerDL (225) for the corresponding HARQ process in the first symbol after the expiry of drx-HARQ-RTT-TimerDL (220).

The UE is considered in active time when drx-RetransmissionTimerDL (225) is running.

FIG. 2B illustrates an operation of a UE and a base station according to an embodiment of the disclosure.

Referring to FIG. 2B, when Connected Mode UE specific DRX is configured, a UE may:
if the PDCCH (230) indicates a UL transmission or if a MAC PDU is transmitted in a configured uplink grant for unicast:
   start a drx-HARQ-RTT-TimerUL (240) for the corresponding HARQ process in the first symbol after the end of the last transmission (within a bundle) of the corresponding PUSCH transmission (235) or in the first symbol after the end of the first transmission (within a bundle) of the corresponding PUSCH transmission (235);
   stop a drx-RetransmissionTimerUL (240), if running, for the corresponding HARQ process at the first transmission (within a bundle) of the corresponding PUSCH transmission (235).
if the drx-HARQ-RTT-TimerUL (240) expires:
   start the drx-RetransmissionTimerUL (245) for the corresponding HARQ process in the first symbol after the expiry of drx-HARQ-RTT-TimerUL (240).

The UE is considered in active time when drx-RetransmissionTimerUL (245) is running.

With the advancement of wireless communication systems, there is a need for network energy savings, leading to discussions about Cell Discontinuous Transmission (DTX) and/or Cell DRX. In the disclosure, Cell DTX and Cell DRX are interchangeable with network (NW) DTX and NW DRX, respectively. Cell DTX and/or Cell DRX can be configured wherein:
periodic cell DTX/DRX pattern is configured by UE-specific RRC signaling message.
Cell DTX and Cell DRX modes can be configured and operated separately (e.g. one RRC configuration set for DL and the other set for UL).
UE specific DRX can be configured in a cell supporting Cell DTX and/or Cell DRX.

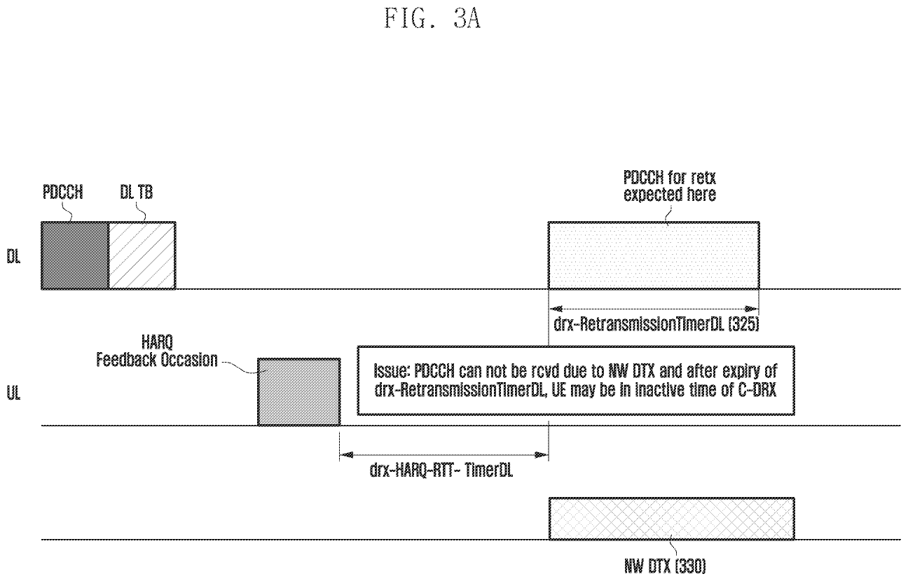

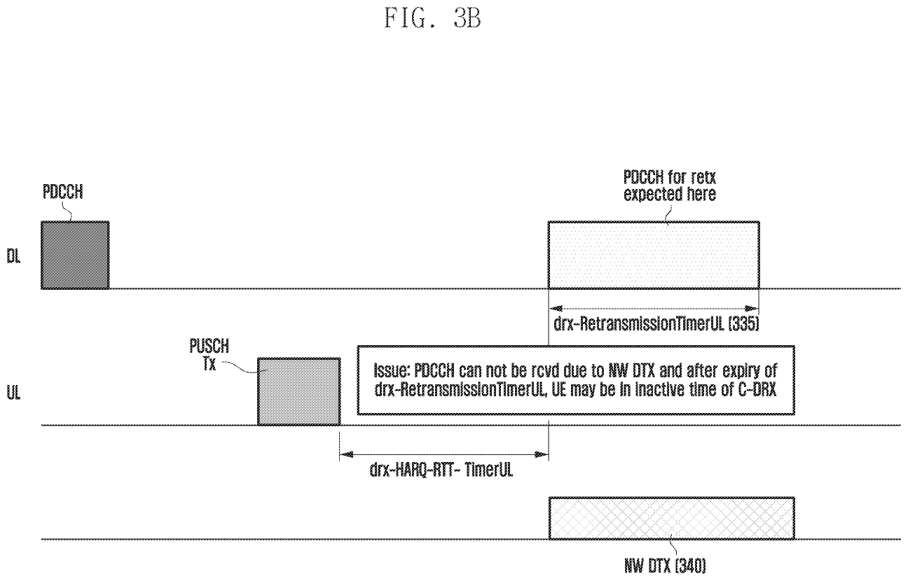

FIG. 3A illustrates an operation of a UE and a base station according to an embodiment of the disclosure.

Referring to FIG. 3A, if drx-RetransmissionTimerDL (325) duration overlaps with NW DTX duration (330), UE may not be able to receive PDCCH for retransmission.

FIG. 3B illustrates an operation of a UE and a base station according to an embodiment of the disclosure.

Referring to FIG. 3B, if drx-RetransmissionTimerUL (335) duration overlaps with NW DTX duration (340), UE may not be able to receive PDCCH for retransmission.

### Method 1

When a UE is in RRC_CONNECTED state, the UE may be configured with connected mode DRX configuration (as described above) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g. one RRC configuration set for DL and the other set for UL). UE specific DRX can be configured in a cell supporting Cell DTX and/or Cell DRX.

Periodic cell DTX pattern may be configured by a ‘duration’ and ‘period’ field, wherein during the ‘duration’ interval which occurs periodically every ‘period’, a cell may not perform transmission (or stop certain transmissions (e.g. PDCCH, PDSCH, PBCH, SSBs, etc.)) and a UE may not perform reception (or stop certain receptions (e.g. (e.g. PDCCH, PDSCH, PBCH, SSBs, etc.)) from the cell.

Alternately, a periodic cell DTX pattern may be configured by a ‘duration’ and ‘period’ field, wherein during the ‘duration’ interval which occurs periodically every ‘period’, a cell may perform transmission, and wherein during the interval ‘period-duration’, the cell may not perform transmission (or stop certain transmissions (e.g. PDCCH, PDSCH, PBCH, SSBs, etc.)) and a UE may not perform reception (or stop certain receptions (e.g. (e.g. PDCCH, PDSCH, PBCH, SSBs, etc.)) from the cell.

Periodic cell DRX pattern may be configured by a ‘duration’ and ‘period’ field, wherein during the ‘duration’ interval which occurs periodically every ‘period’, a cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic cell DRX pattern may be configured by a ‘duration’ and ‘period’ field, wherein during the ‘duration’ interval which occurs periodically every ‘period’, a cell may perform reception, and wherein during the interval ‘period-duration’ the cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the cell level DRX duration where the network (i.e. base station) does not receive transmission (or certain transmissions e.g. PUCCH, PUSCH, PRACH etc.) from UE on the uplink of that cell, the UE may not transmit (or does not transmit) certain transmissions in uplink of that cell.

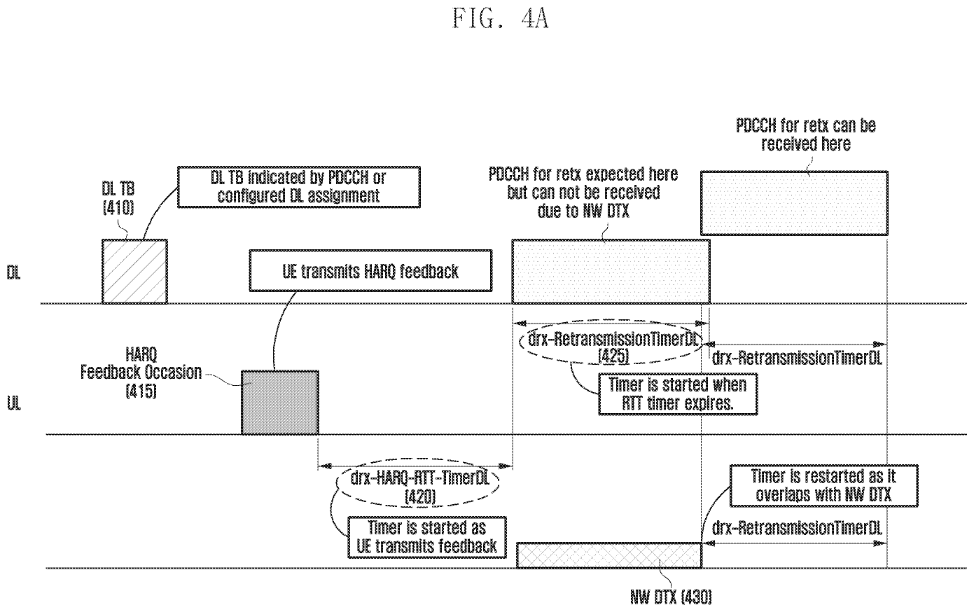

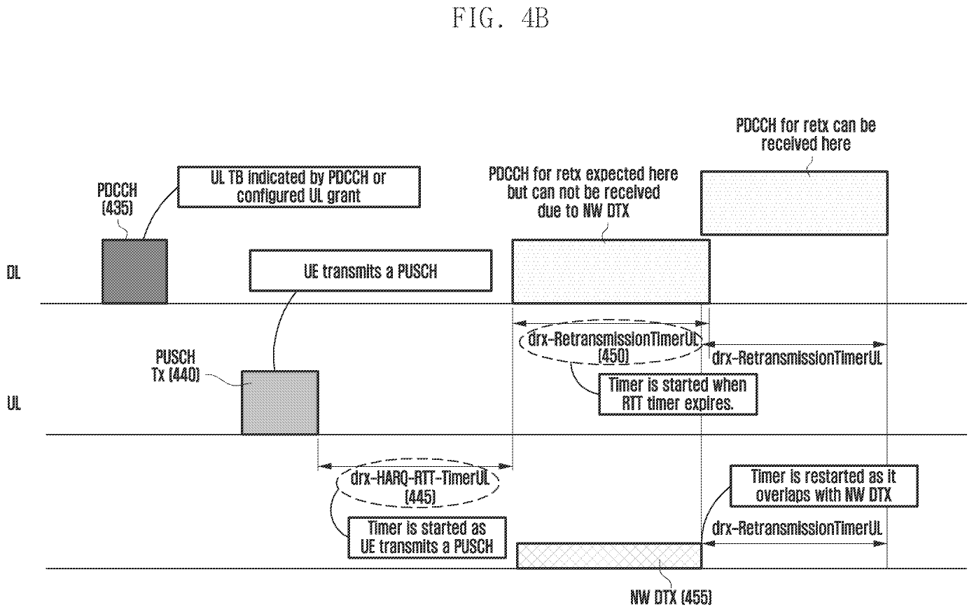

FIG. 4A illustrates an operation of a UE and a base station according to an embodiment of the disclosure.

Referring to FIG. 4A, a UE (or MAC entity in UE) may receive a DL TB (410) or PDSCH indicated by a PDCCH (i.e. resources for DL TB/PDSCH are indicated by the PDCCH) or receive a MAC PDU in a configured downlink assignment (indicated by configured grant type 1 or configured grant type 2 configuration indicating periodic resources for DL/PDSCH transmission) for unicast:
The UE or (MAC entity in UE) may transmit DL HARQ feedback in HARQ feedback occasion (415).
The UE or (MAC entity in UE) may start a drx-HARQ-RTT-TimerDL (420) for the corresponding HARQ process in the first symbol after the end of the corresponding transmission carrying the DL HARQ feedback;
The UE or (MAC entity in UE) may stop a drx-RetransmissionTimerDL (425), if running, for the corresponding HARQ process.
If a drx-HARQ-RTT-TimerDL (420) expires, the UE may:
   if the data of the corresponding HARQ process was not successfully decoded, start the drx-RetransmissionTimerDL (425) for the corresponding HARQ process in the first symbol after the expiry of drx-HARQ-RTT-TimerDL (420). In various embodiments, drx-RetransmissionTimerDL (425) may be started even if HARQ feedback is not transmitted and/or drx-HARQ-RTT-TimerDL (420) is not started;
[Case 1: there is no secondary cells configured for cell group/MAC entity or one or more secondary cells are configured for cell group/MAC entity but none of secondary cells are activated]—If running drx-RetransmissionTimerDL (425) overlaps (partially or fully) with network DTX duration (430) of SpCell (i.e. cell level DTX duration of cell from which PDCCH for retransmission is received); or
[Case 2: In addition to SpCell there are one or more activated Scells in the cell group/MAC entity]—If running drx-RetransmissionTimerDL (425) overlaps (partially or fully) with network DTX duration (430) of SpCell and activated Scells (note that this condition will not be met if there is at least one serving cell (SpCell or activated Scell) in cell group/MAC entity for which network DTX is not configured); Alternatively, if PDCCH cannot be monitored during the drx-RetransmissionTimerDL (425) in neither SpCell nor activated Scells due to network DTX; or
[Case 2: In addition to SpCell there are one or more activated Scells in the cell group/MAC entity]—If running drx-RetransmissionTimerDL (425) overlaps (partially or fully) with network DTX duration (430) of any serving cell (or specific serving cell e.g. SpCell or serving cell indicated by network) in cell group/MAC entity:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for DL transmission. The base station may transmit DL TB in the indicated resources (these resources are PDSCH resources of a cell). The resources for DL transmission can also be a configured downlink assignment (indicated by configured grant type 1 or configured grant type 2 configuration indicating periodic resources for DL/PDSCH transmission) for unicast.
Upon transmitting the DL TB or PDSCH, HARQ feedback is expected from UE in HARQ feedback occasion corresponding to the DL TB.
The base station may receive DL HARQ feedback in the HARQ feedback occasion.
The base station may start a drx-HARQ-RTT-TimerDL for the corresponding HARQ process in the first symbol after the end of the corresponding transmission carrying the DL HARQ feedback;
The base station may stop a drx-RetransmissionTimerDL, if running, for the corresponding HARQ process.
If a drx-HARQ-RTT-TimerDL expires, the base station may:
   if the data of the corresponding HARQ process was not successfully decoded (i.e. HARQ NACK is received), start the drx-RetransmissionTimerDL for the corresponding HARQ process in the first symbol after the expiry of drx-HARQ-RTT-TimerDL.
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received); or
[Case 2: In addition to SpCell there are one or more activated Scells in the cell group/MAC entity]—If running drx-RetransmissionTimerDL overlaps (partially or fully) with network DTX duration of SpCell and activated Scells (note that as an example this condition will not be met if there is at least one serving cell (SpCell or activated Scell) in cell group/MAC entity for which network DTX is not configured); Alternatively, if PDCCH cannot be monitored during the drx-RetransmissionTimerDL in neither SpCell nor activated Scells due to network DTX; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) in cell group/MAC entity:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

FIG. 4B illustrates an operation of a UE and a base station according to an embodiment of the disclosure.

Referring to FIG. 4B, a UE (or MAC entity in UE) may receive a PDCCH (435) indicating a UL/PUSCH transmission (i.e. resources for UL/PUSCH transmission) or transmit a MAC PDU in a configured uplink grant (indicated by configured grant type 1 or configured grant type 2 configuration indicating periodic resources for UL/PUSCH transmission) for unicast:
The UE or (MAC entity in UE) may start the drx-HARQ-RTT-TimerUL (445) for the corresponding HARQ process in the first symbol after the end of the last transmission (within a bundle) of the corresponding PUSCH transmission (440) or in the first symbol after the end of the first transmission (within a bundle) of the corresponding PUSCH transmission (440);
The UE or (MAC entity in UE) may stop a drx-RetransmissionTimerUL (450), if running, for the corresponding HARQ process.
If a drx-HARQ-RTT-TimerUL (445) expires:
   the UE or (MAC entity in UE) may start the drx-RetransmissionTimerUL (450) for the corresponding HARQ process in the first symbol after the expiry of drx-HARQ-RTT-TimerUL (445). In various embodiments, drx-RetransmissionTimerUL (450) may be started even if PUSCH is not transmitted and/or drx-HARQ-RTT-TimerUL (445) is not started;
[Case 1: there is no secondary cells configured for cell group/MAC entity or one or more secondary cells are configured for cell group/MAC entity but none of secondary cells are activated]—If running drx-RetransmissionTimerUL (450) overlaps (partially or fully) with network DTX duration (455) of SpCell (i.e. cell level DTX duration of cell from which PDCCH for retransmission is received); or
[Case 2: In addition to SpCell there are one or more activated SCells in the cell group/MAC entity]—If running drx-RetransmissionTimerUL (450) overlaps (partially or fully) with network DTX duration (455) of SpCell and activated SCells (note that this condition will not be met if there is at least one serving cell (SpCell or activated SCell) in cell group/MAC entity for which network DTX is not configured); Alternatively, if PDCCH can not be monitored during the drx-RetransmissionTimerUL (450) in neither SpCell nor activated SCells due to network DTX; or
[Case 3: In addition to SpCell there are one or more activated SCells in the cell group/MAC entity]—If running drx-RetransmissionTimerUL (450) overlaps (partially or fully) with network DTX duration (455) of any serving cell (or specific serving cell e.g. SpCell or serving cell indicated by network) in cell group/MAC entity:
drx-RetransmissionTimerUL is restarted in the first symbol after the end of the NW DTX duration (i.e. upon end of network DTX duration). In an embodiment, the network (i.e. base station/gNB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for UL transmission. The UE may transmit UL TB in the indicated resources (these resources are PUSCH resources of a cell). The resources for UL transmission can also be a configured uplink grant (indicated by configured grant type 1 or configured grant type 2 configuration indicating periodic resources for UL/PUSCH transmission) for unicast.
The base station may receive UL PUSCH.
The base station may start a drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The base station may stop a drx-RetransmissionTimerUL, if running, for the corresponding HARQ process.
If a drx-HARQ-RTT-TimerUL expires:
   start the drx-RetransmissionTimerUL for the corresponding HARQ process in the first symbol after the expiry of drx-HARQ-RTT-TimerUL.
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received); or
[Case 2: In addition to SpCell there are one or more activated SCells in the cell group/MAC entity]—If running drx-RetransmissionTimerUL overlaps (partially or fully) with network DTX duration of SpCell and activated SCells (note that as an example this condition will not be met if there is at least one serving cell (SpCell or activated SCell) in cell group/MAC entity for which network DTX is not configured); Alternatively, if PDCCH can not be monitored during the drx-RetransmissionTimerUL in neither SpCell nor activated SCells due to network DTX; or
[Case 2: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) in cell group/MAC entity:
drx-RetransmissionTimerUL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

### Method 2

When a UE is in RRC_CONNECTED state, the UE may be configured with connected mode DRX configuration (as described above) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g. one RRC configuration set for DL and the other set for UL). UE specific DRX can be configured in a cell supporting Cell DTX and/or Cell DRX.

Periodic cell DTX pattern may be configured by a ‘duration’ and ‘period’ field, wherein during the ‘duration’ interval which occurs periodically every ‘period’, a cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Alternately, a periodic cell DTX pattern may be configured by a ‘duration’ and ‘period’ field, wherein during the ‘duration’ interval which occurs periodically every ‘period’, a cell may perform transmission, and wherein during the interval ‘period-duration’, the cell may not perform transmission (or stop certain transmissions (e.g. PDSCH, PBCH, SSBs, etc.)) and a UE may not perform reception (or stop certain receptions ((e.g. PDCCH, PDSCH, PBCH, SSBs, etc.)) from the cell.

Periodic cell DRX pattern may be configured by a ‘duration’ and ‘period’ field, wherein during the ‘duration’ interval which occurs periodically every ‘period’, a cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic cell DRX pattern may be configured by a ‘duration’ and ‘period’ field, wherein during the ‘duration’ interval which occurs periodically every ‘period’, a cell may perform reception, and wherein during the interval ‘period-duration’the cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the cell level DRX duration where the network (i.e. base station) does not receive transmission (or certain transmissions e.g. PUCCH, PUSCH, PRACH etc.) from UE on the uplink of that cell, the UE may not transmit (or does not transmit) certain transmissions in uplink of that cell.

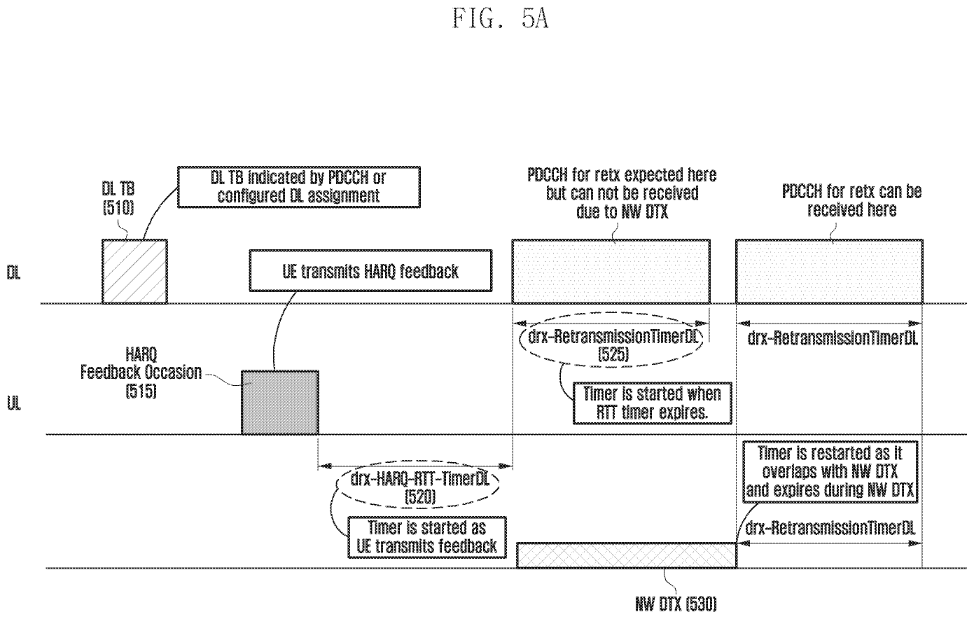

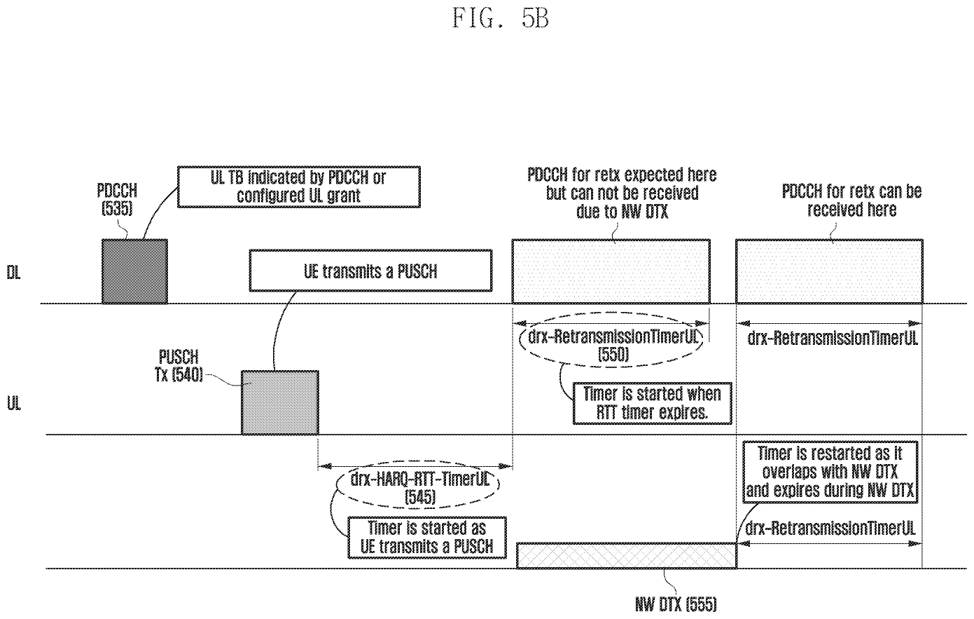

FIG. 5A illustrates an operation of a UE and a base station according to an embodiment of the disclosure.

Referring to FIG. 5A, a UE (or MAC entity in UE) may receive a DL TB (510) or PDSCH indicated by a PDCCH (i.e. resources for DL TB/PDSCH are indicated by the PDCCH) or receive a MAC PDU in a configured downlink assignment (indicated by configured grant type 1 or configured grant type 2 configuration indicating periodic resources for DL/PDSCH transmission) for unicast:
The UE or (MAC entity in UE) may transmit DL HARQ feedback in HARQ feedback occasion (515).
The UE or (MAC entity in UE) may start a drx-HARQ-RTT-TimerDL (520) for the corresponding HARQ process in the first symbol after the end of the corresponding transmission carrying the DL HARQ feedback;
The UE or (MAC entity in UE) may stop a drx-RetransmissionTimerDL (525), if running, for the corresponding HARQ process.
If a drx-HARQ-RTT-TimerDL (520) expires, the UE may:
   if the data of the corresponding HARQ process was not successfully decoded, start the drx-RetransmissionTimerDL (525) for the corresponding HARQ process in the first symbol after the expiry of drx-HARQ-RTT-TimerDL (520). In various embodiments, drx-RetransmissionTimerDL (525) may be started even if HARQ feedback is not transmitted and/or drx-HARQ-RTT-TimerDL (520) is not started;
[Case 1: there is no secondary cells configured for cell group/MAC entity or one or more secondary cells are configured for cell group/MAC entity but none of secondary cells are activated]—If running drx-RetransmissionTimerDL (525) overlaps (partially or fully) with network DTX duration (530) of SpCell (i.e. cell level DTX duration of cell from which PDCCH for retransmission is received) and drx-RetransmissionTimerDL (525) expires during the network DTX duration (530); Alternatively, if running drx-RetransmissionTimerDL (525) expires during the network DTX duration (530); or
[Case 2: In addition to SpCell there are one or more activated Scells in the cell group/MAC entity]—If running drx-RetransmissionTimerDL (525) overlaps (partially or fully) with network DTX duration (530) of SpCell and activated Scells (note that this condition will not be met if there is at least one serving cell (SpCell or activated Scell) in cell group/MAC entity for which network DTX is not configured) and drx-RetransmissionTimerDL (525) expires during the network DTX duration (530); or
[Case 2: In addition to SpCell there are one or more activated Scells in the cell group/MAC entity]—If running drx-RetransmissionTimerDL (525) overlaps (partially or fully) with network DTX duration (530) of any serving cell (or specific serving cell e.g. SpCell or serving cell indicated by network) and drx-RetransmissionTimerDL (525) expires during the network DTX duration (530):
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for DL transmission. The base station may transmit DL TB in the indicated resources (these resources are PDSCH resources of a cell). The resources for DL transmission can also be a configured downlink assignment (indicated by configured grant type 1 or configured grant type 2 configuration indicating periodic resources for DL/PDSCH transmission) for unicast.
Upon transmitting the DL TB or PDSCH, HARQ feedback is expected from UE in HARQ feedback occasion corresponding to the DL TB.
The base station may receive DL HARQ feedback in the HARQ feedback occasion.
The base station may start a drx-HARQ-RTT-TimerDL for the corresponding HARQ process in the first symbol after the end of the corresponding transmission carrying the DL HARQ feedback;
The base station may stop a drx-RetransmissionTimerDL, if running, for the corresponding HARQ process.
If a drx-HARQ-RTT-TimerDL expires, the base station may:
   if the data of the corresponding HARQ process was not successfully decoded (i.e. HARQ NACK is received), start the drx-RetransmissionTimerDL for the corresponding HARQ process in the first symbol after the expiry of drx-HARQ-RTT-TimerDL.
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received) and drx-RetransmissionTimerDL expires during the network DTX duration; Alternatively, if running drx-RetransmissionTimerDL expires during the network DTX duration; or
[Case 2: In addition to SpCell there are one or more activated Scells in the cell group/MAC entity]—If running drx-RetransmissionTimerDL overlaps (partially or fully) with network DTX duration of SpCell and activated Scells (note that this condition will not be met if there is at least one serving cell (SpCell or activated Scell) in cell group/MAC entity for which network DTX is not configured) and drx-RetransmissionTimerDL expires during the network DTX duration; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) and drx-RetransmissionTimerDL expires during the network DTX duration:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

FIG. 5B illustrates an operation of a UE and a base station according to an embodiment of the disclosure.

Referring to FIG. 5B, a UE (or MAC entity in UE) may receive a PDCCH (535) indicating a UL/PUSCH transmission (i.e. resources for UL/PUSCH transmission) or transmit a MAC PDU in a configured uplink grant (indicated by configured grant type 1 or configured grant type 2 configuration indicating periodic resources for UL/PUSCH transmission) for unicast:
The UE or (MAC entity in UE) may start the drx-HARQ-RTT-TimerUL (545) for the corresponding HARQ process in the first symbol after the end of the last transmission (within a bundle) of the corresponding PUSCH transmission (540) or in the first symbol after the end of the first transmission (within a bundle) of the corresponding PUSCH transmission (540);
The UE or (MAC entity in UE) may stop a drx-RetransmissionTimerUL (550), if running, for the corresponding HARQ process.
If a drx-HARQ-RTT-TimerUL (545) expires:
   the UE or (MAC entity in UE) may start the drx-RetransmissionTimerUL (550) for the corresponding HARQ process in the first symbol after the expiry of drx-HARQ-RTT-TimerUL (545). In various embodiments, drx-RetransmissionTimerUL (550) may be started even if PUSCH is not transmitted and/or drx-HARQ-RTT-TimerUL (545) is not started;
[Case 1: there is no secondary cells configured for cell group/MAC entity or one or more secondary cells are configured for cell group/MAC entity but none of secondary cells are activated]—If running drx-RetransmissionTimerUL (550) overlaps (partially or fully) with network DTX duration (555) of SpCell (i.e. cell level DTX duration of cell from which PDCCH for retransmission is received) and drx-RetransmissionTimerUL (550) expires during the network DTX duration (555); Alternatively. if running drx-RetransmissionTimerUL (550) expires during the network DTX duration (555); or
[Case 2: In addition to SpCell there are one or more activated SCells in the cell group/MAC entity]—If running drx-RetransmissionTimerUL (550) overlaps (partially or fully) with network DTX duration (555) of SpCell and activated SCells (note that this condition will not be met if there is at least one serving cell (SpCell or activated SCell) in cell group/MAC entity for which network DTX is not configured) and drx-RetransmissionTimerUL (550) expires during the network DTX duration (555); or
[Case 3: In addition to SpCell there are one or more activated SCells in the cell group/MAC entity]—If running drx-RetransmissionTimerUL (550) overlaps (partially or fully) with network DTX duration (555) of any serving cell (or specific serving cell e.g. SpCell or serving cell indicated by network) and drx-RetransmissionTimerUL (550) expires during the network DTX duration (555):
drx-RetransmissionTimerUL is restarted in the first symbol after the end of the NW DTX duration (i.e. upon end of network DTX duration). In an embodiment, the network (i.e. base station/gNB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for UL transmission. The UE may transmit UL TB in the indicated resources (these resources are PUSCH resources of a cell). The resources for UL transmission can also be a configured uplink grant (indicated by configured grant type 1 or configured grant type 2 configuration indicating periodic resources for UL/PUSCH transmission) for unicast.
The base station may receive UL PUSCH.
The base station may start a drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The base station may stop a drx-RetransmissionTimerUL, if running, for the corresponding HARQ process.
If a drx-HARQ-RTT-TimerUL expires:
   start the drx-RetransmissionTimerUL for the corresponding HARQ process in the first symbol after the expiry of drx-HARQ-RTT-TimerUL.
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received) and drx-RetransmissionTimerUL expires during the network DTX duration; Alternatively, if running drx-RetransmissionTimerUL expires during the network DTX duration; or
[Case 2: In addition to SpCell there are one or more activated SCells in the cell group/MAC entity]—If running drx-RetransmissionTimerUL overlaps (partially or fully) with network DTX duration of SpCell and activated SCells (note that this condition will not be met if there is at least one serving cell (SpCell or activated SCell) in cell group/MAC entity for which network DTX is not configured) and drx-RetransmissionTimerUL expires during the network DTX duration; or
[Case 3: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) and drx-RetransmissionTimerUL expires during the network DTX duration:
drx-RetransmissionTimerUL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

### Method 3

When a UE is in RRC_CONNECTED state, the UE may be configured with connected mode DRX configuration (as described above) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g. one RRC configuration set for DL and the other set for UL). UE specific DRX can be configured in a cell supporting Cell DTX and/or Cell DRX.

Periodic cell DTX pattern may be configured by a ‘duration’ and ‘period’ field, wherein during the ‘duration’ interval which occurs periodically every ‘period’, a cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Alternately, a periodic cell DTX pattern may be configured by a ‘duration’ and ‘period’ field, wherein during the ‘duration’ interval which occurs periodically every ‘period’, a cell may perform transmission, and wherein during the interval ‘period-duration’, the cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Periodic cell DRX pattern may be configured by a ‘duration’ and ‘period’ field, wherein during the ‘duration’ interval which occurs periodically every ‘period’, a cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic cell DRX pattern may be configured by a ‘duration’ and ‘period’ field, wherein during the ‘duration’ interval which occurs periodically every ‘period’, a cell may perform reception, and wherein during the interval ‘period-duration’ the cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the cell level DRX duration where the network (i.e. base station) does not receive transmission (or certain transmissions e.g. PUCCH, PUSCH, PRACH etc.) from UE on the uplink of that cell, the UE may not transmit (or does not transmit) certain transmissions in uplink of that cell.

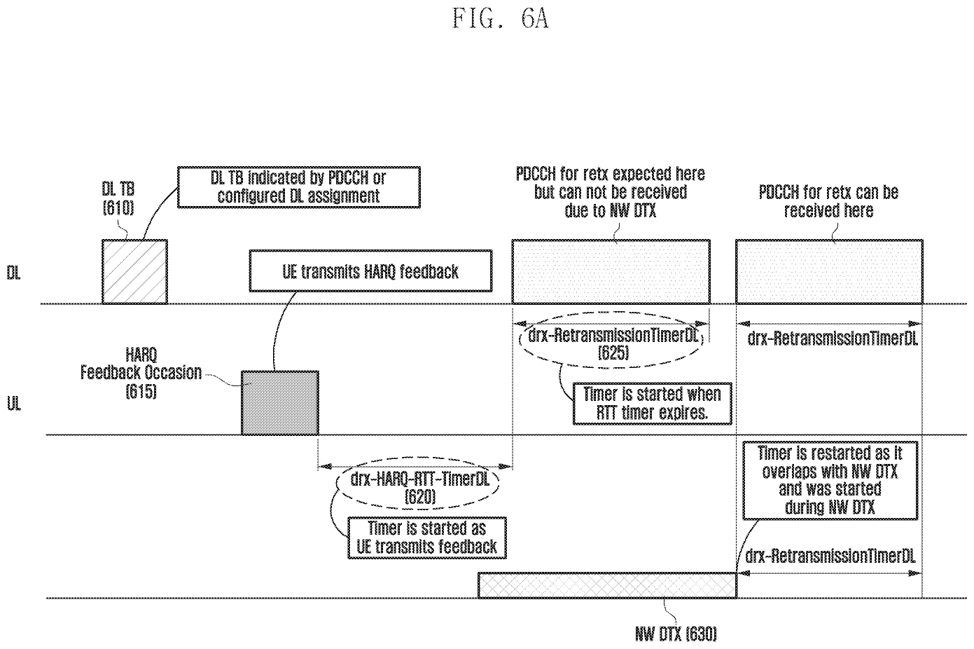

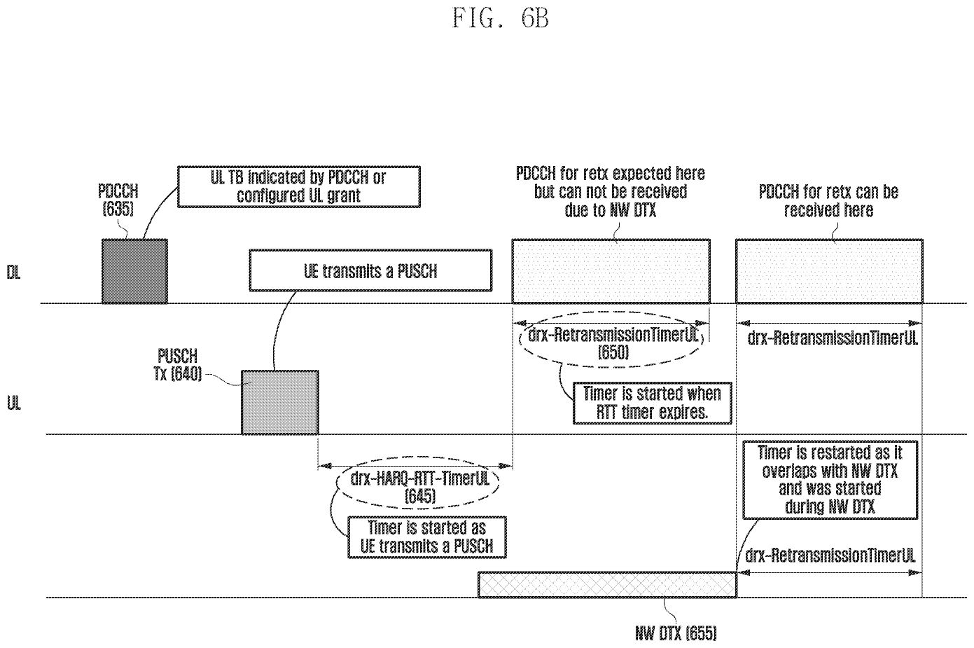

FIG. 6A illustrates an operation of a UE and a base station according to an embodiment of the disclosure.

Referring to FIG. 6A, a UE (or MAC entity in UE) may receive a DL TB (610) or PDSCH indicated by a PDCCH (i.e. resources for DL TB/PDSCH are indicated by the PDCCH) or receive a MAC PDU in a configured downlink assignment (indicated by configured grant type 1 or configured grant type 2 configuration indicating periodic resources for DL/PDSCH transmission) for unicast:
The UE or (MAC entity in UE) may transmit DL HARQ feedback in HARQ feedback occasion (615).
The UE or (MAC entity in UE) may start a drx-HARQ-RTT-TimerDL (620) for the corresponding HARQ process in the first symbol after the end of the corresponding transmission carrying the DL HARQ feedback;
The UE or (MAC entity in UE) may stop a drx-RetransmissionTimerDL (625), if running, for the corresponding HARQ process.
If a drx-HARQ-RTT-TimerDL (620) expires, the UE may:
   if the data of the corresponding HARQ process was not successfully decoded, start the drx-RetransmissionTimerDL (625) for the corresponding HARQ process in the first symbol after the expiry of drx-HARQ-RTT-TimerDL (620). In various embodiments, drx-RetransmissionTimerDL (625) may be started even if HARQ feedback is not transmitted and/or drx-HARQ-RTT-TimerDL (620) is not started;
[Case 1: there is no secondary cells configured for cell group/MAC entity or one or more secondary cells are configured for cell group/MAC entity but none of secondary cells are activated]—If running drx-RetransmissionTimerDL (625) overlaps (partially or fully) with network DTX duration (630) of SpCell (i.e. cell level DTX duration of cell from which PDCCH for retransmission is received) and drx-RetransmissionTimerDL was started during the network DTX duration; Alternatively, if drx-RetransmissionTimerDL (625) was started during the network DTX duration (630); or
[Case 2: In addition to SpCell there are one or more activated Scells in the cell group/MAC entity]—If running drx-RetransmissionTimerDL (625) overlaps (partially or fully) with network DTX duration (630) of SpCell and activated Scells (note that this condition will not be met if there is at least one serving cell (SpCell or activated Scell) in cell group/MAC entity for which network DTX is not configured) and drx-RetransmissionTimerDL (625) was started during the network DTX duration (630); or
[Case 2: In addition to SpCell there are one or more activated Scells in the cell group/MAC entity]—If running drx-RetransmissionTimerDL (625) overlaps (partially or fully) with network DTX duration (630) of any serving cell (or specific serving cell e.g. SpCell or serving cell indicated by network) and drx-RetransmissionTimerDL (625) was started during the network DTX duration (630):
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for DL transmission. The base station may transmit DL TB in the indicated resources (these resources are PDSCH resources of a cell). The resources for DL transmission can also be a configured downlink assignment (indicated by configured grant type 1 or configured grant type 2 configuration indicating periodic resources for DL/PDSCH transmission) for unicast.
Upon transmitting the DL TB or PDSCH, HARQ feedback is expected from UE in HARQ feedback occasion corresponding to the DL TB.
The base station may receive DL HARQ feedback in the HARQ feedback occasion.
The base station may start a drx-HARQ-RTT-TimerDL for the corresponding HARQ process in the first symbol after the end of the corresponding transmission carrying the DL HARQ feedback;
The base station may stop a drx-RetransmissionTimerDL, if running, for the corresponding HARQ process.
If a drx-HARQ-RTT-TimerDL expires, the base station may:
   if the data of the corresponding HARQ process was not successfully decoded (i.e. HARQ NACK is received), start the drx-RetransmissionTimerDL for the corresponding HARQ process in the first symbol after the expiry of drx-HARQ-RTT-TimerDL.
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received) and drx-RetransmissionTimerDL was started during the network DTX duration; OR If drx-RetransmissionTimerDL was started during the network DTX duration; or
[Case 2: In addition to SpCell there are one or more activated Scells in the cell group/MAC entity]—If running drx-RetransmissionTimerDL overlaps (partially or fully) with network DTX duration of SpCell and activated Scells (note that this condition will not be met if there is at least one serving cell (SpCell or activated Scell) in cell group/MAC entity for which network DTX is not configured) and drx-RetransmissionTimerDL was started during the network DTX duration; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) and drx-RetransmissionTimerDL was started during the network DTX duration:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

FIG. 6B illustrates an operation of a UE and a base station according to an embodiment of the disclosure.

Referring to FIG. 6B, a UE (or MAC entity in UE) may receive a PDCCH (635) indicating a UL/PUSCH transmission (i.e. resources for UL/PUSCH transmission) or transmit a MAC PDU in a configured uplink grant (indicated by configured grant type 1 or configured grant type 2 configuration indicating periodic resources for UL/PUSCH transmission) for unicast:
The UE or (MAC entity in UE) may start the drx-HARQ-RTT-TimerUL (645) for the corresponding HARQ process in the first symbol after the end of the last transmission (within a bundle) of the corresponding PUSCH transmission (640) or in the first symbol after the end of the first transmission (within a bundle) of the corresponding PUSCH transmission (640);
The UE or (MAC entity in UE) may stop a drx-RetransmissionTimerUL (650), if running, for the corresponding HARQ process.
If a drx-HARQ-RTT-TimerUL (645) expires:
   the UE or (MAC entity in UE) may start the drx-RetransmissionTimerUL (650) for the corresponding HARQ process in the first symbol after the expiry of drx-HARQ-RTT-TimerUL (645). In various embodiments, drx-RetransmissionTimerUL (650) may be started even if PUSCH is not transmitted and/or drx-HARQ-RTT-TimerUL (645) is not started;
[Case 1: there is no secondary cells configured for cell group/MAC entity or one or more secondary cells are configured for cell group/MAC entity but none of secondary cells are activated]—If running drx-RetransmissionTimerUL (650) overlaps (partially or fully) with network DTX duration (655) of SpCell (i.e. cell level DTX duration of cell from which PDCCH for retransmission is received) and drx-RetransmissionTimerUL (650) was started during the network DTX duration (655); Alternatively, if drx-RetransmissionTimerUL (650) was started during the network DTX duration (655); or
[Case 2: In addition to SpCell there are one or more activated SCells in the cell group/MAC entity]—If running drx-RetransmissionTimerUL (650) overlaps (partially or fully) with network DTX duration (655) of SpCell and activated SCells (note that this condition will not be met if there is at least one serving cell (SpCell or activated SCell) in cell group/MAC entity for which network DTX is not configured) and drx-RetransmissionTimerUL (650) was started during the network DTX duration (655); or
[Case 3: In addition to SpCell there are one or more activated SCells in the cell group/MAC entity]—If running drx-RetransmissionTimerUL (650) overlaps (partially or fully) with network DTX duration (655) of any serving cell (or specific serving cell e.g. SpCell or serving cell indicated by network) and drx-RetransmissionTimerUL (650) was started during the network DTX duration (655):
drx-RetransmissionTimerUL is restarted in the first symbol after the end of the NW DTX duration (i.e. upon end of network DTX duration). In an embodiment, the network (i.e. base station/gNB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for UL transmission. The UE may transmit UL TB in the indicated resources (these resources are PUSCH resources of a cell). The resources for UL transmission can also be a configured uplink grant (indicated by configured grant type 1 or configured grant type 2 configuration indicating periodic resources for UL/PUSCH transmission) for unicast.
The base station may receive UL PUSCH.
The base station may start a drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The base station may stop a drx-RetransmissionTimerUL, if running, for the corresponding HARQ process.
If a drx-HARQ-RTT-TimerUL expires:
   start the drx-RetransmissionTimerUL for the corresponding HARQ process in the first symbol after the expiry of drx-HARQ-RTT-TimerUL.
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received) and drx-RetransmissionTimerUL was started during the network DTX duration; Alternatively, if drx-RetransmissionTimerUL was started during the network DTX duration; or
[Case 2: In addition to SpCell there are one or more activated SCells in the cell group/MAC entity]—If running drx-RetransmissionTimerUL overlaps (partially or fully) with network DTX duration of SpCell and activated SCells (note that this condition will not be met if there is at least one serving cell (SpCell or activated SCell) in cell group/MAC entity for which network DTX is not configured) and drx-RetransmissionTimerUL was started during the network DTX duration; or
[Case 3: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) and drx-RetransmissionTimerUL was started during the network DTX duration:
drx-RetransmissionTimerUL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

### Method 4

When a UE is in RRC_CONNECTED state, the UE may be configured with connected mode DRX configuration (as described above) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g. one RRC configuration set for DL and the other set for UL). UE specific DRX can be configured in a cell supporting Cell DTX and/or Cell DRX.

Periodic cell DTX pattern may be configured by a ‘duration’ and ‘period’ field, wherein during the ‘duration’ interval which occurs periodically every ‘period’, a cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Alternately, a periodic cell DTX pattern may be configured by a ‘duration’ and ‘period’ field, wherein during the ‘duration’ interval which occurs periodically every ‘period’, a cell may perform transmission, and wherein during the interval ‘period-duration’, the cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Periodic cell DRX pattern may be configured by a ‘duration’ and ‘period’ field, wherein during the ‘duration’ interval which occurs periodically every ‘period’, a cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic cell DRX pattern may be configured by a ‘duration’ and ‘period’ field, wherein during the ‘duration’ interval which occurs periodically every ‘period’, a cell may perform reception, and wherein during the interval ‘period-duration’the cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the cell level DRX duration where the network (i.e. base station) does not receive transmission (or certain transmissions e.g. PUCCH, PUSCH, PRACH etc.) from UE on the uplink of that cell, the UE may not transmit (or does not transmit) certain transmissions in uplink of that cell.

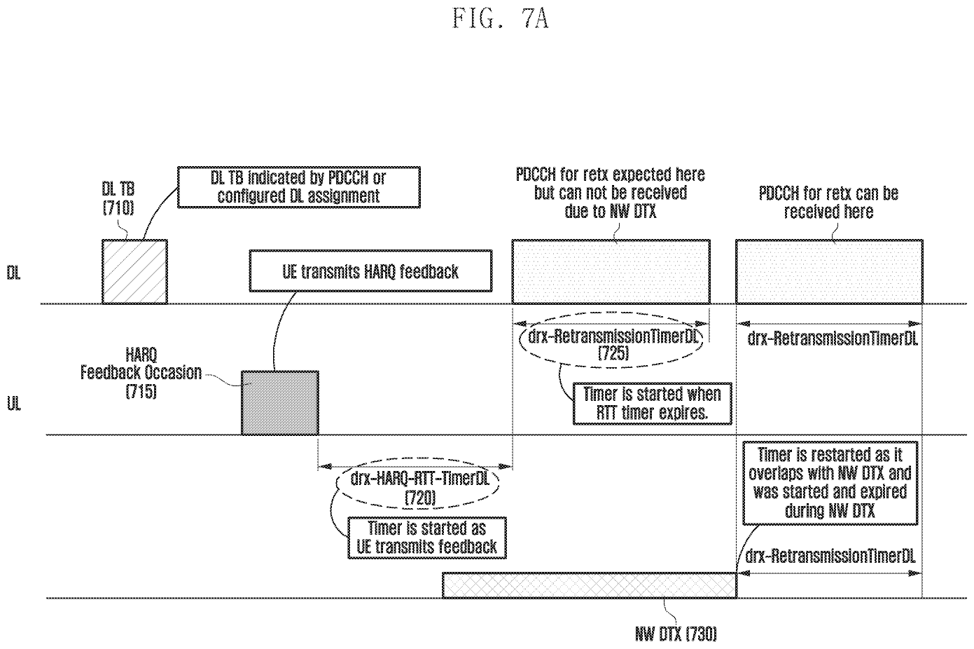

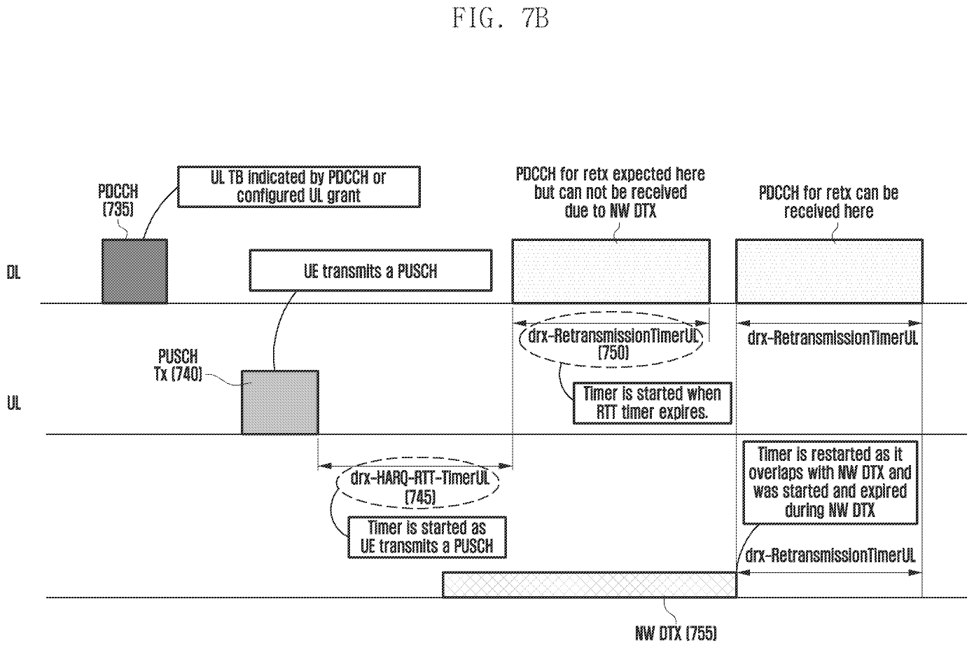

FIG. 7A illustrates an operation of a UE and a base station according to an embodiment of the disclosure.

Referring to FIG. 7A, a UE (or MAC entity in UE) may receive a DL TB (710) or PDSCH indicated by a PDCCH (i.e. resources for DL TB/PDSCH are indicated by the PDCCH) or receive a MAC PDU in a configured downlink assignment (indicated by configured grant type 1 or configured grant type 2 configuration indicating periodic resources for DL/PDSCH transmission) for unicast:
The UE or (MAC entity in UE) may transmit DL HARQ feedback in HARQ feedback occasion (715).
The UE or (MAC entity in UE) may start a drx-HARQ-RTT-TimerDL (720) for the corresponding HARQ process in the first symbol after the end of the corresponding transmission carrying the DL HARQ feedback;
The UE or (MAC entity in UE) may stop a drx-RetransmissionTimerDL (725), if running, for the corresponding HARQ process.
If a drx-HARQ-RTT-TimerDL (720) expires, the UE may:
   if the data of the corresponding HARQ process was not successfully decoded, start the drx-RetransmissionTimerDL (725) for the corresponding HARQ process in the first symbol after the expiry of drx-HARQ-RTT-TimerDL (720). In various embodiments, drx-RetransmissionTimerDL (725) may be started even if HARQ feedback is not transmitted and/or drx-HARQ-RTT-TimerDL (720) is not started;
[Case 1: there is no secondary cells configured for cell group/MAC entity or one or more secondary cells are configured for cell group/MAC entity but none of secondary cells are activated]—If running drx-RetransmissionTimerDL (725) overlaps (partially or fully) with network DTX duration (730) of SpCell (i.e. cell level DTX duration of cell from which PDCCH for retransmission is received) and drx-RetransmissionTimerDL (725) was started during the network DTX duration (730) and expires during the network DTX duration (730); Alternatively, if drx-RetransmissionTimerDL (725) was started during the network DTX duration (730) and expires during the network DTX duration (730); or
[Case 2: In addition to SpCell there are one or more activated Scells in the cell group/MAC entity]—If running drx-RetransmissionTimerDL (725) overlaps (partially or fully) with network DTX duration (730) of SpCell and activated Scells (note that this condition will not be met if there is at least one serving cell (SpCell or activated Scell) in cell group/MAC entity for which network DTX is not configured) and drx-RetransmissionTimerDL (725) was started during the network DTX duration (730) and expires during the network DTX duration (730); or
[Case 2: In addition to SpCell there are one or more activated Scells in the cell group/MAC entity]—If running drx-RetransmissionTimerDL (725) overlaps (partially or fully) with network DTX duration (730) of any serving cell (or specific serving cell e.g. SpCell or serving cell indicated by network) and drx-RetransmissionTimerDL (725) was started during the network DTX duration (730) and expires during the network DTX duration (730):
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for DL transmission. The base station may transmit DL TB in the indicated resources (these resources are PDSCH resources of a cell). The resources for DL transmission can also be a configured downlink assignment (indicated by configured grant type 1 or configured grant type 2 configuration indicating periodic resources for DL/PDSCH transmission) for unicast.
Upon transmitting the DL TB or PDSCH, HARQ feedback is expected from UE in HARQ feedback occasion corresponding to the DL TB.
The base station may receive DL HARQ feedback in the HARQ feedback occasion.
The base station may start a drx-HARQ-RTT-TimerDL for the corresponding HARQ process in the first symbol after the end of the corresponding transmission carrying the DL HARQ feedback;
The base station may stop a drx-RetransmissionTimerDL, if running, for the corresponding HARQ process.
If a drx-HARQ-RTT-TimerDL expires, the base station may:
   if the data of the corresponding HARQ process was not successfully decoded (i.e. HARQ NACK is received), start the drx-RetransmissionTimerDL for the corresponding HARQ process in the first symbol after the expiry of drx-HARQ-RTT-TimerDL.
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received) and drx-RetransmissionTimerDL was started during the network DTX duration and expires during the network DTX duration; Alternatively, if drx-RetransmissionTimerDL was started during the network DTX duration and expires during the network DTX duration; or
[Case 2: In addition to SpCell there are one or more activated Scells in the cell group/MAC entity]—If running drx-RetransmissionTimerDL overlaps (partially or fully) with network DTX duration of SpCell and activated Scells (note that this condition will not be met if there is at least one serving cell (SpCell or activated Scell) in cell group/MAC entity for which network DTX is not configured) and drx-RetransmissionTimerDL was started during the network DTX duration and expires during the network DTX duration; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) and drx-RetransmissionTimerDL was started during the network DTX duration and expires during the network DTX duration:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

FIG. 7B illustrates an operation of a UE and a base station according to an embodiment of the disclosure.

Referring to FIG. 7B, a UE (or MAC entity in UE) may receive a PDCCH (735) indicating a UL/PUSCH transmission (i.e. resources for UL/PUSCH transmission) or transmit a MAC PDU in a configured uplink grant (indicated by configured grant type 1 or configured grant type 2 configuration indicating periodic resources for UL/PUSCH transmission) for unicast:
The UE or (MAC entity in UE) may start the drx-HARQ-RTT-TimerUL (745) for the corresponding HARQ process in the first symbol after the end of the last transmission (within a bundle) of the corresponding PUSCH transmission (740) or in the first symbol after the end of the first transmission (within a bundle) of the corresponding PUSCH transmission (740);
The UE or (MAC entity in UE) may stop a drx-RetransmissionTimerUL (750), if running, for the corresponding HARQ process.
If a drx-HARQ-RTT-TimerUL (745) expires:
   the UE or (MAC entity in UE) may start the drx-RetransmissionTimerUL (750) for the corresponding HARQ process in the first symbol after the expiry of drx-HARQ-RTT-TimerUL (745). In various embodiments, drx-RetransmissionTimerUL (750) may be started even if PUSCH is not transmitted and/or drx-HARQ-RTT-TimerUL (745) is not started;
[Case 1: there is no secondary cells configured for cell group/MAC entity or one or more secondary cells are configured for cell group/MAC entity but none of secondary cells are activated]—If running drx-RetransmissionTimerUL (750) overlaps (partially or fully) with network DTX duration (755) of SpCell (i.e. cell level DTX duration of cell from which PDCCH for retransmission is received) and drx-RetransmissionTimerUL (750) was started during the network DTX duration (755) and expires during the network DTX duration (755); Alternatively, if drx-RetransmissionTimerUL (750) was started during the network DTX duration (755) and expires during the network DTX duration (755); or
[Case 2: In addition to SpCell there are one or more activated SCells in the cell group/MAC entity]—If running drx-RetransmissionTimerUL (750) overlaps (partially or fully) with network DTX duration (755) of SpCell and activated SCells (note that this condition will not be met if there is at least one serving cell (SpCell or activated SCell) in cell group/MAC entity for which network DTX is not configured) and drx-RetransmissionTimerUL (750) was started during the network DTX duration (755) and expires during the network DTX duration (755); or
[Case 3: In addition to SpCell there are one or more activated SCells in the cell group/MAC entity]—If running drx-RetransmissionTimerUL (750) overlaps (partially or fully) with network DTX duration (755) of any serving cell (or specific serving cell e.g. SpCell or serving cell indicated by network) and drx-RetransmissionTimerUL (750) was started during the network DTX duration (755) and expires during the network DTX duration (755):
drx-RetransmissionTimerUL is restarted in the first symbol after the end of the NW DTX duration (i.e. upon end of network DTX duration). In an embodiment, the network (i.e. base station/gNB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for UL transmission. The UE may transmit UL TB in the indicated resources (these resources are PUSCH resources of a cell). The resources for UL transmission can also be a configured uplink grant (indicated by configured grant type 1 or configured grant type 2 configuration indicating periodic resources for UL/PUSCH transmission) for unicast.
The base station may receive UL PUSCH.
The base station may start a drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The base station may stop a drx-RetransmissionTimerUL, if running, for the corresponding HARQ process.
If a drx-HARQ-RTT-TimerUL expires:
   start the drx-RetransmissionTimerUL for the corresponding HARQ process in the first symbol after the expiry of drx-HARQ-RTT-TimerUL.
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received) and drx-RetransmissionTimerUL was started during the network DTX duration and expires during the network DTX duration; Alternatively, if drx-RetransmissionTimerUL was started during the network DTX duration and expires during the network DTX duration; or
[Case 2: In addition to SpCell there are one or more activated SCells in the cell group/MAC entity]—If running drx-RetransmissionTimerUL overlaps (partially or fully) with network DTX duration of SpCell and activated SCells (note that this condition will not be met if there is at least one serving cell (SpCell or activated SCell) in cell group/MAC entity for which network DTX is not configured) and drx-RetransmissionTimerUL was started during the network DTX duration and expires during the network DTX duration; or
[Case 3: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) and drx-RetransmissionTimerUL was started during the network DTX duration and expires during the network DTX duration:
drx-RetransmissionTimerUL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

### Method 5

When a UE is in RRC_CONNECTED state, the UE may be configured with connected mode DRX configuration (as described above) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g. one RRC configuration set for DL and the other set for UL). UE specific DRX can be configured in a cell supporting Cell DTX and/or Cell DRX.

Periodic cell DTX pattern may be configured by a ‘duration’ and ‘period’ field, wherein during the ‘duration’ interval which occurs periodically every ‘period’, a cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Alternately, a periodic cell DTX pattern may be configured by a ‘duration’ and ‘period’ field, wherein during the ‘duration’ interval which occurs periodically every ‘period’, a cell may perform transmission, and wherein during the interval ‘period-duration’, the cell may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the cell.

Periodic cell DRX pattern may be configured by a ‘duration’ and ‘period’ field, wherein during the ‘duration’ interval which occurs periodically every ‘period’, a cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic cell DRX pattern may be configured by a ‘duration’ and ‘period’ field, wherein during the ‘duration’ interval which occurs periodically every ‘period’, a cell may perform reception, and wherein during the interval ‘period-duration’ the cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the cell level DRX duration where the network (i.e. base station) does not receive transmission (or certain transmissions e.g. PUCCH, PUSCH, PRACH etc.) from UE on the uplink of that cell, the UE may not transmit (or does not transmit) certain transmissions in uplink of that cell.

A UE (or MAC entity in UE) may receive a DL TB or PDSCH indicated by a PDCCH (i.e. resources for DL TB/PDSCH are indicated by the PDCCH) or receive a MAC PDU in a configured downlink assignment (indicated by configured grant type 1 or configured grant type 2 configuration indicating periodic resources for DL/PDSCH transmission) for unicast:
The UE or (MAC entity in UE) may transmit DL HARQ feedback in HARQ feedback occasion.
The UE or (MAC entity in UE) may start a drx-HARQ-RTT-TimerDL for the corresponding HARQ process in the first symbol after the end of the corresponding transmission carrying the DL HARQ feedback;
The UE or (MAC entity in UE) may stop a drx-RetransmissionTimerDL, if running, for the corresponding HARQ process.
If a drx-HARQ-RTT-TimerDL expires, the UE may:
   if the data of the corresponding HARQ process was not successfully decoded, start the drx-RetransmissionTimerDL for the corresponding HARQ process in the first symbol after the expiry of drx-HARQ-RTT-TimerDL. In various embodiments, drx-RetransmissionTimerDL may be started even if HARQ feedback is not transmitted and/or drx-HARQ-RTT-TimerDL is not started;
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received) and if drx-HARQ-RTT-TimerDL is expired during the network DTX duration; Alternatively, if drx-HARQ-RTT-TimerDL is expired during the network DTX duration; or
[Case 2: In addition to SpCell there are one or more activated Scells in the cell group/MAC entity]—If running drx-RetransmissionTimerDL overlaps (partially or fully) with network DTX duration of SpCell and activated Scells (note that this condition will not be met if there is at least one serving cell (SpCell or activated Scell) in cell group/MAC entity for which network DTX is not configured) and if drx-HARQ-RTT-TimerDL is expired during the network DTX duration; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) and if drx-HARQ-RTT-TimerDL is expired during the network DTX duration:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for DL transmission. The base station may transmit DL TB in the indicated resources (these resources are PDSCH resources of a cell). The resources for DL transmission can also be a configured downlink assignment (indicated by configured grant type 1 or configured grant type 2 configuration indicating periodic resources for DL/PDSCH transmission) for unicast.
Upon transmitting the DL TB or PDSCH, HARQ feedback is expected from UE in HARQ feedback occasion corresponding to the DL TB.
The base station may receive DL HARQ feedback in the HARQ feedback occasion.
The base station may start a drx-HARQ-RTT-TimerDL for the corresponding HARQ process in the first symbol after the end of the corresponding transmission carrying the DL HARQ feedback;
The base station may stop a drx-RetransmissionTimerDL, if running, for the corresponding HARQ process.
If a drx-HARQ-RTT-TimerDL expires, the base station may:
   if the data of the corresponding HARQ process was not successfully decoded (i.e. HARQ NACK is received), start the drx-RetransmissionTimerDL for the corresponding HARQ process in the first symbol after the expiry of drx-HARQ-RTT-TimerDL.
[Case 1: there is no secondary cells configured for cell group/MAC entity or one or more secondary cells are configured for cell group/MAC entity but none of secondary cells are activated]—If running drx-RetransmissionTimerDL overlaps (partially or fully) with network DTX duration of SpCell (i.e. cell level DTX duration of cell from which PDCCH for retransmission is received) and if drx-HARQ-RTT-TimerDL is expired during the network DTX duration; Alternatively, if drx-HARQ-RTT-TimerDL is expired during the network DTX duration; or
[Case 2: In addition to SpCell there are one or more activated Scells in the cell group/MAC entity]—If running drx-RetransmissionTimerDL overlaps (partially or fully) with network DTX duration of SpCell and activated Scells (note that this condition will not be met if there is at least one serving cell (SpCell or activated Scell) in cell group/MAC entity for which network DTX is not configured) and if drx-HARQ-RTT-TimerDL is expired during the network DTX duration; or
[Case 2: In addition to SpCell there are one or more activated Scells in the cell group/MAC entity]—If running drx-RetransmissionTimerDL overlaps (partially or fully) with network DTX duration of any serving cell (or specific serving cell e.g. SpCell or serving cell indicated by network) and if drx-HARQ-RTT-TimerDL is expired during the network DTX duration:
drx-RetransmissionTimerDL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerDL in the first symbol after the end of the NW DTX duration. If such indication is received, drx-RetransmissionTimerDL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

In methods explained above the value of drx-RetransmissionTimerDL for restarting the timer from end of NW DTX duration can be different from the value of drx-RetransmissionTimerDL for starting the timer when RTT timer expires. In alternate embodiments of methods explained above instead of restarting the drx-RetransmissionTimerDL from the first symbol after the end of network DTX duration, drx-RetransmissionTimerDL can be started after an offset from the end of network DTX duration, where the offset may be signaled by the network in RRC signaling or system information. In an embodiment, if drx-RetransmissionTimerDL overlaps with NW DTX duration and is still running after the end of NW DTX duration, drx-RetransmissionTimerDL may be restarted upon expiry of drx-RetransmissionTimerDL, if the UE has not received the PDCCH for retransmission while the drx-RetransmissionTimerDL was running.

A UE (or MAC entity in UE) may receive a PDCCH indicating a UL/PUSCH transmission (i.e. resources for UL/PUSCH transmission) or transmit a MAC PDU in a configured uplink grant (indicated by configured grant type 1 or configured grant type 2 configuration indicating periodic resources for UL/PUSCH transmission) for unicast:
The UE or (MAC entity in UE) may start the drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The UE or (MAC entity in UE) may stop a drx-RetransmissionTimerUL, if running, for the corresponding HARQ process.
If a drx-HARQ-RTT-TimerUL expires:
   the UE or (MAC entity in UE) may start the drx-RetransmissionTimerUL for the corresponding HARQ process in the first symbol after the expiry of drx-HARQ-RTT-TimerUL. In various embodiments, drx-RetransmissionTimerUL may be started even if PUSCH is not transmitted and/or drx-HARQ-RTT-TimerUL is not started;
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received) and if drx-HARQ-RTT-TimerUL is expired during the network DTX duration; Alternatively, if drx-HARQ-RTT-TimerUL is expired during the network DTX duration; or
[Case 2: In addition to SpCell there are one or more activated SCells in the cell group/MAC entity]—If running drx-RetransmissionTimerUL overlaps (partially or fully) with network DTX duration of SpCell and activated SCells (note that this condition will not be met if there is at least one serving cell (SpCell or activated SCell) in cell group/MAC entity for which network DTX is not configured) and if drx-HARQ-RTT-TimerUL is expired during the network DTX duration; or
[Case 3: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) and if drx-HARQ-RTT-TimerUL is expired during the network DTX duration:
drx-RetransmissionTimerUL is restarted in the first symbol after the end of the NW DTX duration (i.e. upon end of network DTX duration). In an embodiment, the network (i.e. base station/gNB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

The base station may configure cell specific DRX for one or more serving cells. During the cell level DRX duration of a cell, the network (i.e. base station) may not receive transmission (or certain transmissions) from UE on the uplink of that cell.

The base station may transmit PDCCH indicating resources for UL transmission. The UE may transmit UL TB in the indicated resources (these resources are PUSCH resources of a cell). The resources for UL transmission can also be a configured uplink grant (indicated by configured grant type 1 or configured grant type 2 configuration indicating periodic resources for UL/PUSCH transmission) for unicast.
The base station may receive UL PUSCH.
The base station may start a drx-HARQ-RTT-TimerUL for the corresponding HARQ process in the first symbol after the end of the last transmission (within a bundle) of the corresponding PUSCH transmission or in the first symbol after the end of the first transmission (within a bundle) of the corresponding PUSCH transmission;
The base station may stop a drx-RetransmissionTimerUL, if running, for the corresponding HARQ process.
If a drx-HARQ-RTT-TimerUL expires:
   start the drx-RetransmissionTimerUL for the corresponding HARQ process in the first symbol after the expiry of drx-HARQ-RTT-TimerUL.
[Case 1: there is no secondary cells configured for cell group/MAC entity or one or more secondary cells are configured for cell group/MAC entity but none of secondary cells are activated]—If running drx-RetransmissionTimerUL overlaps (partially or fully) with network DTX duration of SpCell (i.e. cell level DTX duration of cell from which PDCCH for retransmission is received) and if drx-HARQ-RTT-TimerUL is expired during the network DTX duration; Alternatively, if drx-HARQ-RTT-TimerUL is expired during the network DTX duration; or
[Case 2: In addition to SpCell there are one or more activated SCells in the cell group/MAC entity]—If running drx-RetransmissionTimerUL overlaps (partially or fully) with network DTX duration of SpCell and activated SCells (note that this condition will not be met if there is at least one serving cell (SpCell or activated SCell) in cell group/MAC entity for which network DTX is not configured) and if drx-HARQ-RTT-TimerUL is expired during the network DTX duration; or
[Case 3: In addition to SpCell there are one or more activated SCells in the cell group/MAC entity]—If running drx-RetransmissionTimerUL overlaps (partially or fully) with network DTX duration of any serving cell (or specific serving cell e.g. SpCell or serving cell indicated by network) and if drx-HARQ-RTT-TimerUL is expired during the network DTX duration:
drx-RetransmissionTimerUL is restarted in the first symbol after the end of the NW DTX duration (i.e. upon end of network DTX duration). In an embodiment, the network (i.e. base station/gnB) may configure (e.g. the network may send an indication in RRC signaling or PDCCH/DCI or system information, the indication can be per cell or per cell group or per BWP, and the UE may apply the indication accordingly) that UE restarts drx-RetransmissionTimerUL in the first symbol after the end of the NW DTX duration. If such indication is received, drx-RetransmissionTimerUL is restarted in the first symbol after the end of the NW DTX duration (i.e. upon end of network DTX duration).

In an embodiment, the network DTX duration in the above description can be the cell level inactive duration where the cell does not perform any transmission to a UE or does not perform any dedicated transmission to a UE or does not perform certain transmissions (e.g. PDSCH, PBCH, etc.) to a UE.

In methods explained above, the value of drx-RetransmissionTimerUL for restarting the timer from end of NW DTX duration can be different from the value of drx-RetransmissionTimerUL for starting the timer when RTT timer expires. In alternate embodiments of methods explained above instead of restarting the drx-RetransmissionTimerUL from the first symbol after the end of network DTX duration, drx-RetransmissionTimerUL can be started after an offset from the end of network DTX duration, where the offset may be signalled by network in RRC signalling or system information. In an embodiment, if drx-RetransmissionTimerUL overlaps with NW DTX duration and is still running after the end of NW DTX duration, drx-RetransmissionTimerUL may be restarted upon expiry of drx-RetransmissionTimerUL, if the UE has not received the PDCCH for retransmission while the drx-RetransmissionTimerUL was running.

The NW DTX/DRX operation may be configured per transmit/receive point (TRP). Here, the term TRP can be used interchangeably with a CORESET group/pool, spatial relation information, or a beam or a set of RSs.

Periodic NW DTX pattern per TRP of a cell may be configured by a ‘duration’ and ‘period’ field, wherein during the ‘duration’ interval which occurs periodically every ‘period’, a TRP may not perform transmission (or stop certain transmissions (e.g. PDCCH, PDSCH, PBCH, SSBs, etc.)) and a UE may not perform reception (or stop certain receptions (e.g. PDCCH, PDSCH, PBCH, SSBs, etc.)) from the TRP.

Alternately, a periodic NW DTX pattern per TRP of a cell may be configured by a ‘duration’ and ‘period’ field, wherein during the ‘duration’ interval which occurs periodically every ‘period’, a TRP of cell may perform transmission, and wherein during the interval ‘period-duration’, the TRP of cell may not perform transmission (or stop certain transmissions (e.g. PDSCH, PBCH, SSBs, etc.)) and a UE may not perform reception (or stop certain receptions (e.g. PDCCH, PDSCH, PBCH, SSBs, etc.)) from the TRP.

In this case activation/deactivation of NW DTX pattern is per TRP. The activation/deactivation command may include a TRP ID or an index indicating TRP or NW DTX pattern configuration index, wherein each TRP is distinguished by a unique index.

Periodic NW DRX pattern for TRP of a cell may be configured by a ‘duration’ and ‘period’ field, wherein during the ‘duration’ interval which occurs periodically every ‘period’, a TRP may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

Alternately, a periodic NW DRX pattern for TRP of a cell may be configured by a ‘duration’ and ‘period’ field, wherein during the ‘duration’ interval which occurs periodically every ‘period’, a TRP of cell may perform reception, and wherein during the interval ‘period-duration’, the TRP of cell may not perform reception (or stop certain receptions e.g. PUCCH, PUSCH, PRACH etc.) and a UE may not perform transmission or stop transmission (or stop certain transmissions e.g. PUCCH, PUSCH, PRACH etc.).

During the TRP level NW DRX duration where the network (i.e. base station) does not receive transmission (or certain transmissions e.g. PUCCH, PUSCH, PRACH etc.) from UE on the uplink of that TRP of cell, the UE may not transmit (or does not transmit) certain transmissions in uplink of that TRP of cell.

In an embodiment, in a case that the network (i.e. base station/gNB) configures and activates NW DTX configuration, UE/gNB will periodically switch off reception/transmission in NW DTX duration occurring periodically. Here, the NW DTX configuration can be configured per TRP or configured per cell. In a case that the network has data to transmit, the network can transmit outside the NW DTX duration. However, for urgent data, this method may not be efficient. In an embodiment, the network can send a command to a UE to deactivate the NW DTX configuration, to transmit the urgent data and then to activate the NW DTX configuration again. In another embodiment, the network may send a command indicating that the UE skips only the upcoming NW DTX duration instead of deactivating the NW DTX configuration.

In an embodiment. upon activation of NW DTX configuration, specific NW DTX mode (e.g. which signals/channels (such as PDCCH, PDSCH, PBCH, RSs, etc.) are transmitted) for upcoming NW DTX duration can be indicated (e.g. using PDCCH or MAC CE or RRC signaling). If such indication is not received, the UE may fall back to the same mode as in the previous NW DTX duration or fallback to a default mode.

In an embodiment, a UE can request a specific NW DTX mode. For example, in a case that a UE is not in good channel condition (e.g. cell quality (RSRP/RSRQ/SINR/RSSI) is below a configured threshold), transmission of certain RSs (e.g. RLM RSs, BFD RSs etc.) can be beneficial and the UE can request for an NW DTX mode in which the RS(s) are transmitted. Alternatively, the UE can request a gNB to transmit the RS(s) even during the NW DTX duration. L1/L2 signaling to request a specific NW DTX mode, deactivation of NW DTX mode, and/or temporary transmission during the off-duration can also be considered.

In an embodiment, if the inactivity timer is going to overlap with NW DTX duration, one of the following operations can be performed by the UE/gNB for handling of loss time due to lack of monitoring PDCCH:

Restart the inactivity timer upon end of the NW DTX duration, if the inactivity timer overlaps with the NW DTX duration.

Restart the inactivity timer upon end of the NW DTX duration, if the inactivity timer is expired during the NW DTX duration.

Restart the inactivity timer upon end of the NW DTX duration, if the duration that the inactivity timer overlaps with the NW DTX duration is greater than a threshold T. T can be configured through RRC message or DCI by network.

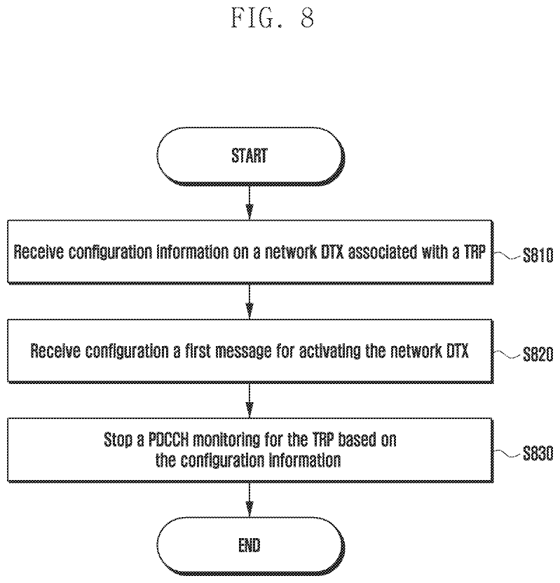

FIG. 8 illustrates an operation of a UE according to an embodiment of the disclosure.

Referring to FIG. 8, in operation S810, a UE may receive configuration information on a network discontinuous transmission (DTX) associated with a transmit/receive point (TRP).

In operation S820, the UE may receive a first message for activating the network DTX.

In operation S830, the UE may stop a physical downlink control channel (PDCCH) monitoring for the TRP based on the configuration information.

In an embodiment, the configuration information may include information on a duration and a period of the network DTX.

In an embodiment, the UE may receive a second message for one of deactivating the network DTX or skipping an upcoming network DTX duration, and receive downlink data, by one of deactivating the network DTX or skipping a network DTX duration, following the reception of the second message.

In an embodiment, the UE may transmit a request for a specific network DTX mode for reference signal transmission, and receive a reference signal during a network DTX duration.

In an embodiment, if a discontinuous reception (DRX) retransmission timer for downlink overlaps with a network DTX duration, the UE may restart the DRX retransmission timer for downlink upon end of the network DTX duration.

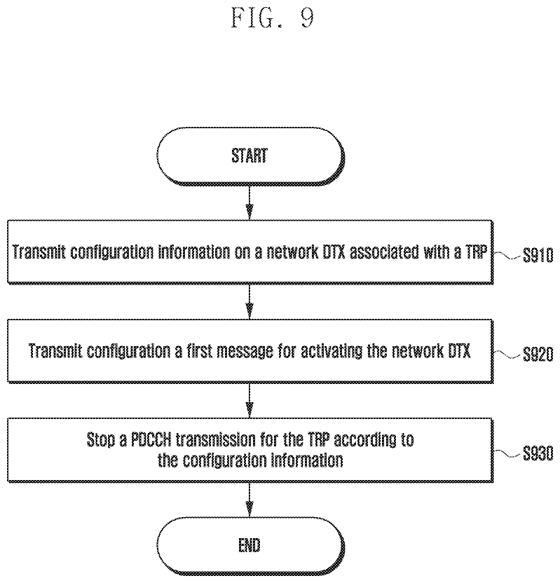

FIG. 9 illustrates an operation of a base station according to an embodiment of the disclosure.

Referring to FIG. 9, in operation S910, a base station may transmit configuration information on a network discontinuous transmission (DTX) associated with a transmit/receive point (TRP).

In operation S920, the base station may transmit a first message for activating the network DTX.

In operation S930, the base station may stop a physical downlink control channel (PDCCH) transmission for the TRP according to the configuration information.

In an embodiment, the configuration information may include information on a duration and a period of the network DTX.

In an embodiment, the base station may transmit a second message for one of deactivating the network DTX or skipping an upcoming network DTX duration, and transmit downlink data, by one of deactivating the network DTX or skipping a network DTX duration, following the transmission of the second message.

In an embodiment, the base station may receive a request for a specific network DTX mode for reference signal transmission, and transmit a reference signal during a network DTX duration.

In an embodiment, if a discontinuous reception (DRX) retransmission timer for downlink overlaps with a network DTX duration, the base station may restart the DRX retransmission timer for downlink upon end of the network DTX duration.

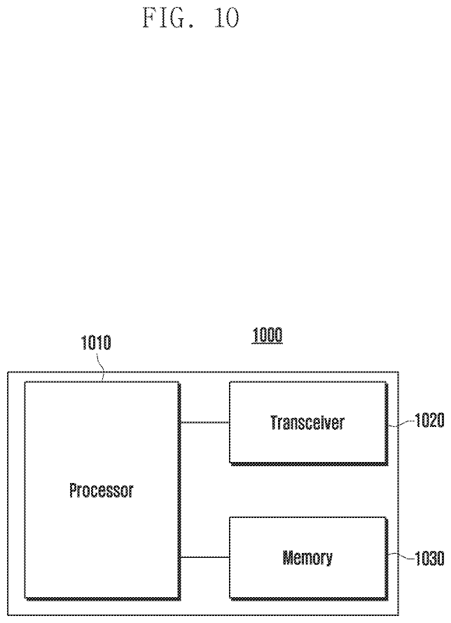

FIG. 10 illustrates an electronic device according to an embodiment of the disclosure.

Referring to FIG. 10, the electronic device 1000 may include a processor 1010, a transceiver 1020, and memory 1030. However, all of the illustrated components are not essential. The electronic device 1000 may be implemented by more or less components than those illustrated in FIG. 10. In addition, the processor 1010 and the transceiver 1020 and the memory 1030 may be implemented as a single chip according to another embodiment.

The electronic device 1000 may correspond to the UE described above.

The aforementioned components will now be described in detail.

The processor 1010 may include one or more processors or other processing devices that control the proposed function, process, and/or method. Operation of the electronic device 1000 may be implemented by the processor 1010.

The transceiver 1020 may include a radio frequency (RF) transmitter for up-converting and amplifying a transmitted signal, and a RF receiver for down-converting a frequency of a received signal. However, according to another embodiment, the transceiver 1020 may be implemented by more or less components than those illustrated in components.

The transceiver 1020 may be connected to the processor 1010 and transmit and/or receive a signal. The signal may include control information and data. In addition, the transceiver 1020 may receive the signal through a wireless channel and output the signal to the processor 1010. The transceiver 1020 may transmit a signal output from the processor 1010 through the wireless channel.

The memory 1030 may store the control information or the data included in a signal obtained by the electronic device 1000. The memory 1030 may be connected to the processor 1010 and store at least one instruction or a protocol or a parameter for the proposed function, process, and/or method. The memory 1030 may include read-only memory (ROM) and/or random access memory (RAM) and/or hard disk and/or compact disc (CD)-ROM and/or digital versatile disc (DVD) and/or other storage devices.

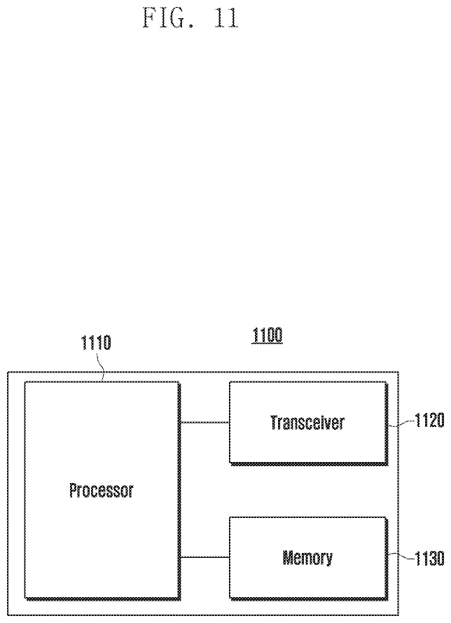

FIG. 11 illustrates a base station according to an embodiment of the disclosure.

Referring to FIG. 11, the base station 1100 may include a processor 1110, a transceiver 1120 and memory 1130. However, all of the illustrated components are not essential. The base station 1100 may be implemented by more or less components than those illustrated in FIG. 11. In addition, the processor 1110 and the transceiver 1120 and the memory 1130 may be implemented as a single chip according to another embodiment.

The base station 1100 may correspond to the gNB described above.

The aforementioned components will now be described in detail.

The processor 1110 may include one or more processors or other processing devices that control the proposed function, process, and/or method. Operation of the base station 1100 may be implemented by the processor 1110.

The transceiver 1120 may include a RF transmitter for up-converting and amplifying a transmitted signal, and a RF receiver for down-converting a frequency of a received signal. However, according to another embodiment, the transceiver 1120 may be implemented by more or less components than those illustrated in components.

The transceiver 1120 may be connected to the processor 1110 and transmit and/or receive a signal. The signal may include control information and data. In addition, the transceiver 1120 may receive the signal through a wireless channel and output the signal to the processor 1110. The transceiver 1120 may transmit a signal output from the processor 1110 through the wireless channel.

The memory 1130 may store the control information or the data included in a signal obtained by the base station 1100. The memory 1130 may be connected to the processor 1110 and store at least one instruction or a protocol or a parameter for the proposed function, process, and/or method. The memory 1130 may include read-only memory (ROM) and/or random access memory (RAM) and/or hard disk and/or CD-ROM and/or DVD and/or other storage devices.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information on a network discontinuous transmission (DTX) associated with a transmit/receive point (TRP);
receiving, from the base station, a first message for activating the network DTX; and
stopping a physical downlink control channel (PDCCH) monitoring for the TRP based on the configuration information.

2. The method of claim 1, wherein the configuration information includes information on a duration and a period of the network DTX.

3. The method of claim 1, further comprising:
receiving, from the base station, a second message for one of deactivating the network DTX or skipping an upcoming network DTX duration; and
receiving, from the base station, downlink data, by one of deactivating the network DTX or skipping a network DTX duration, following the reception of the second message.

4. The method of claim 1, further comprising:
transmitting, to the base station, a request for a specific network DTX mode for reference signal transmission; and
receiving, from the base station, a reference signal during a network DTX duration.

5. The method of claim 1, further comprising:
in case that a discontinuous reception (DRX) retransmission timer for downlink overlaps with a network DTX duration, restarting the DRX retransmission timer for downlink upon end of the network DTX duration.

6. A method performed by a base station in a wireless communication system, the method comprising:
transmitting, to a user equipment (UE), configuration information on a network discontinuous transmission (DTX) associated with a transmit/receive point (TRP);
transmitting, to the UE, a first message for activating the network DTX; and
stopping a physical downlink control channel (PDCCH) transmission for the TRP according to the configuration information.

7. The method of claim 6, wherein the configuration information includes information on a duration and a period of the network DTX.

8. The method of claim 6, further comprising:
transmitting, to the UE, a second message for one of deactivating the network DTX or skipping an upcoming network DTX duration; and
transmitting, to the UE, downlink data, by one of deactivating the network DTX or skipping a network DTX duration, following the transmission of the second message.

9. The method of claim 6, further comprising:
receiving, from the UE, a request for a specific network DTX mode for reference signal transmission; and
transmitting, to the UE, a reference signal during a network DTX duration.

10. The method of claim 6, further comprising:
in case that a discontinuous reception (DRX) retransmission timer for downlink overlaps with a network DTX duration, restarting the DRX retransmission timer for downlink upon end of the network DTX duration.

11. A user equipment (UE) in a wireless communication system, the UE comprising:
a transceiver; and
a controller configured to:
receive, from a base station via the transceiver, configuration information on a network discontinuous transmission (DTX) associated with a transmit/receive point (TRP),
receive, from the base station via the transceiver, a first message for activating the network DTX, and
stop a physical downlink control channel (PDCCH) monitoring for the TRP based on the configuration information.

12. The UE of claim 11, wherein the configuration information includes information on a duration and a period of the network DTX.

13. The UE of claim 11, wherein the controller is further configured to:
receive, from the base station via the transceiver, a second message for one of deactivating the network DTX or skipping an upcoming network DTX duration, and
receive, from the base station via the transceiver, downlink data, by one of deactivating the network DTX or skipping a network DTX duration, following the reception of the second message.

14. The UE of claim 11, wherein the controller is further configured to:
transmit, to the base station via the transceiver, a request for a specific network DTX mode for reference signal transmission, and
receive, from the base station via the transceiver, a reference signal during a network DTX duration.

15. The UE of claim 11, wherein the controller is further configured to:
in case that a discontinuous reception (DRX) retransmission timer for downlink overlaps with a network DTX duration, restart the DRX retransmission timer for downlink upon end of the network DTX duration.

16. A base station in a wireless communication system, the base station comprising:
a transceiver; and
a controller configured to:
transmit, to a user equipment (UE) via the transceiver, configuration information on a network discontinuous transmission (DTX) associated with a transmit/receive point (TRP),
transmit, to the UE via the transceiver, a first message for activating the network DTX, and
stop a physical downlink control channel (PDCCH) transmission for the TRP according to the configuration information.

17. The base station of claim 16, wherein the configuration information includes information on a duration and a period of the network DTX.

18. The base station of claim 16, wherein the controller is further configured to:
transmit, to the UE via the transceiver, a second message for one of deactivating the network DTX or skipping an upcoming network DTX duration, and
transmit, to the UE via the transceiver, downlink data, by one of deactivating the network DTX or skipping a network DTX duration, following the transmission of the second message.

19. The base station of claim 16, wherein the controller is further configured to:
receive, from the UE via the transceiver, a request for a specific network DTX mode for reference signal transmission, and
transmit, to the UE via the transceiver, a reference signal during a network DTX duration.

20. The base station of claim 16, wherein the controller is further configured to:
in case that a discontinuous reception (DRX) retransmission timer for downlink overlaps with a network DTX duration, restart the DRX retransmission timer for downlink upon end of the network DTX duration.
